(19) United States
(12) Patent Application Publication
(10) Pub. No.: US 2005/0119036 A1
(43) Pub. Date: Jun. 2, 2005

(54) Input system and method

(76) Inventors: Amro Albanna, Riverside, CA (US); Rowena Albanna, Riverside, CA (US); Xuejun Tan, Riverside, CA (US); Kirby Clark Dotson, Aliso Viejo, CA (US); David Ralph Addington, Lake Elsinore, CA (US)

Correspondence Address: Steven B. Pokotilow, Esq.;Stroock & Stroock & Lavan LLP, 180 Maiden Lane, New York, NY, 10038, US

(21) Appl. No.: 10/957,338

(22) Filed: Oct. 1, 2004

Related U.S. Application Data
(63) Continuation-in-part of application No. 10/741,308, filed on Dec. 19, 2003.
(60) Provisional application No. 60/508,466, filed on Oct. 3, 2003.
(60) Provisional application No. 60/563,056, filed on Apr. 16, 2004.

(51) Int. Cl. A63F 13/00

(52) U.S. Cl. 463/7

(57) ABSTRACT

Systems and methods for converting a signal representative of movement of an object in a first format into input device data of a second format that a computer application is configured to receive, are described. Certain embodiments of the invention include: a sensor unit including one or more sensors configured to measure movement of the object in one or more directions and create a signal representative of the movement of the object in a first format, a transmitter configured to communicate the signal, and a user station having driver software configured to receive the signal, convert the signal into simulated input device data having the second format, and provide the simulated input device data to the computer application.

### CROSS-REFERENCE TO RELATED APPLICATIONS

This Application is a continuation-in-part of U.S. application Ser. No. 10/741,308, filed on Dec. 19, 2003, entitled INPUT SYSTEM AND METHOD, which claims the benefit of U.S. Provisional Application Ser. No. 60/508,466, filed on Oct. 3, 2003, entitled VIDEO GAME INPUT SYSTEM AND METHOD OF PROVIDING SAME; this Application also claims the benefit of U.S. Provisional Application Ser. No. 60/563,056, filed on Apr. 16, 2004, entitled INPUT SYSTEM AND METHOD, all of which applications are hereby incorporated by reference.

A portion of the disclosure of this patent document contains material which is subject to copyright or mask work protection. The copyright or mask work owner has no objection to the facsimile reproduction by any one of the patent document or the patent disclosure, as it appears in the Patent and Trademark Office patent file or records, but otherwise reserves all copyright or mask work rights whatsoever.

### BACKGROUND OF THE INVENTION

1. Field of the Invention

The present invention relates generally to a video game input system, and, more particularly, to a system and method for converting movement of a moving object into input device data, such as mouse controller input data, to a video game or computer application.

2. Description of Related Art

Video games are a popular form of entertainment. Video games often use input devices, such as a mouse, joystick, keyboard, or other game controller, to receive the input data from the user that is necessary to control the game characters and features of the game. When playing a sports video game, it is desirable to the user to feel like they are actually laying the sport that is the subject of the video game. The aforementioned input devices are generic to all types of video games and do not give the user a realistic feeling of playing a sport. Accordingly, a need exists for a method and system that better captures the realistic feeling of actually playing the sport that is the subject of a video game when the user is providing input to control the game characters and features of the video game.

### SUMMARY OF THE INVENTION

The foregoing need, as well as others, are satisfied by the present invention. According to certain embodiments, systems and methods for converting movement of a moving object into input device data are disclosed.

One embodiment of the invention is directed to a system for use with a computer application configured to respond to first input device data from a first input device, the first input device having a first format. This embodiment of the present invention includes: a second input device, different than the first input device, the second input device including one or more sensors configured to measure movement of an object and creating second input device data representative of the movement of the object, the second input device data having a second format different than the first format; and a processor configured to convert the second input device data into simulated first input device data, the simulated first input device data having the first format, the processor further configured to provide the simulated first input device data to the computer application, thereby simulating the first input device with the second input device.

Another embodiment of the invention is directed to a system for converting movement of an object from a first format into input device data of a second format that a computer application is configured to receive. This embodiment of the present invention includes a sensor unit including: one or more sensors configured to measure movement of the object in one or more directions and create a signal representative of the movement of the object in a first format; a transmitter configured to communicate the signal; and a user station having driver software configured to receive the signal, convert the signal into simulated input device data having the second format, and provide the simulated input device data to the computer application.

Yet another embodiment of the invention is directed to a method of providing input to a computer application configured to receive first input device data having a first format. This embodiment of the present invention includes: measuring movement of an object in one or more directions; creating second input device data representative of the movement of the object, the second input device data having a second format different than the first format; converting the second input device data into simulated first input device data, the simulated first input device data having the first format; and providing the simulated first input device data to the computer application, thereby simulating the first input device with the second input device.

Yet another embodiment of the invention is directed to a system of providing input to a computer application configured to receive first input device data having a first format. This embodiment of the present invention includes: means for measuring movement of an object in one or more directions; means for creating second input device data representative of the movement of the object, the second input device data having a second format different than the first format; means for converting the second input device data into simulated first input device data, the simulated first input device data having the first format; and means for providing the simulated first input device data to the computer application, thereby simulating the first input device with the second input device.

Yet another embodiment of the invention is directed to a method for replicating first input device data of a first input device, the first input device data having a first format, to a computer application, to control movement of a graphical representation of an object. This embodiment of the present invention includes: measuring movement of the object with a second input device; creating an electronic signal representative of the movement of the object, the electronic signal having a second format different from the first format; translating the electronic signal into replicated first input device data having the first format; and making the replicated first input device data available to the computer application, thereby replicating first input device data from the first input device with replicated first input device data for the second input device.

Yet another embodiment of the invention is directed to a computer readable medium comprising code for configuring a processor. This embodiment of the present invention includes: providing simulated input device data to a computer application, the computer application configured to control a graphical representation of an object in response to input device data; and translating a signal into the simulated input device data, the signal representing physical movement of the object, the signal having a signal format incompatible with the computer application and the simulated input device data compatible with the computer application, thereby simulating the input device data.

The invention will next be described in connection with certain exemplary embodiments; however, it should be clear to those skilled in the art that various modifications, additions, and subtractions can be made without departing from the spirit or scope of the claims.

### BRIEF DESCRIPTION OF THE DRAWINGS

The following drawing figures, which are included herewith and form a part of this application, are intended to be illustrative examples and not limiting of the scope of the present invention.

FIG. 1 is a schematic illustrating the components and flow of data according to one embodiment of the present invention.

FIG. 2 is an illustration of the layout of the accelerometers of the sensor unit according to one embodiment of the present invention.

FIG. 3 is a flowchart illustrating the process for using a device and software to play a golf video game according to one embodiment of the present invention.

FIG. 4 is a flowchart illustrating the process for simulating mouse controller movement according to one embodiment of the present invention.

FIG. 5 is a flowchart illustrating the process for determining whether the sensor unit is in static status of the device according to one embodiment of the present invention.

FIGS. 6(a)-6(d) are graphs illustrating the mapping of the angle data to the correct quadrants according to one embodiment of the present invention.

FIGS. 7(a)-7(c) are flowcharts illustrating the process for transformation of the unfiltered angle data to filtered angle data according to one embodiment of the present invention.

FIG. 8 is pseudocode illustrating the process for transformation of raw angle data to correct quadrant angle data according to one embodiment of the present invention.

FIG. 9 is graph illustrating an example of raw angle data, transformed angle data, and raw acceleration data for a three-quarter fast swing according to one embodiment of the present invention.

FIG. 10(a)-10(c) is pseudocode illustrating the process for transforming the angle change of a golf club swing into mouse controller movement data according to one embodiment of the present invention.

FIG. 11 is pseudocode illustrating the process for converting exceptionally large swing data into mouse controller movement data that can be understood by a video game according to one embodiment of the present invention.

FIG. 12 a schematic illustrating the components and flow of data according to another embodiment of the present invention.

FIG. 13 is an illustration of the swing arm assembly component according to one embodiment of the present invention.

FIG. 14 is an illustration of a screen shot of a golf video game according to one embodiment of the present invention.

FIGS. 15-17 are illustrations of graphical user interfaces according to alternate embodiments of the present invention.

### DETAILED DESCRIPTION OF CERTAIN EMBODIMENTS

Certain embodiments of the present invention will now be described in greater detail with reference to the aforementioned figures.

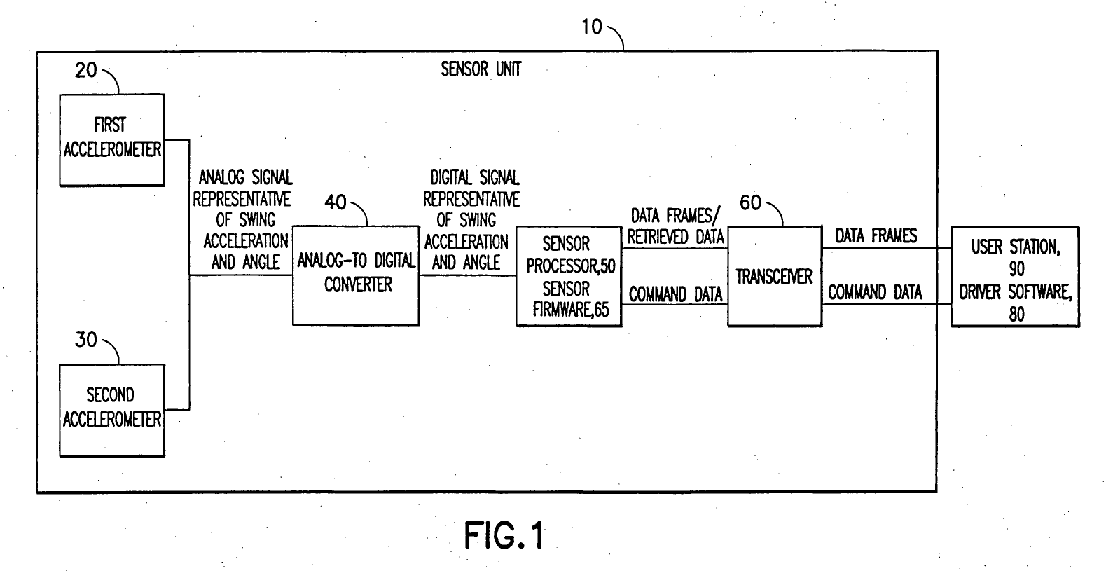

FIG. 1 is a workflow diagram illustrating the components and flow of data according to one embodiment of the present invention. This embodiment of the invention includes: a first sensor 20, a second sensor 30, an analog-to-digital converter 40, a sensor processor 50, a transmitter 60, sensor firmware 65, driver software 80 and a user station 90. In the present embodiment, the first sensor 20 and second sensor 30 are each accelerometers (first accelerometer 20 and second accelerometer 30, collectively, the accelerometers 20). In alternate embodiments, the other types of sensors may be used, such as rate gyros, so as to extract rotational motion in addition to translational motion.

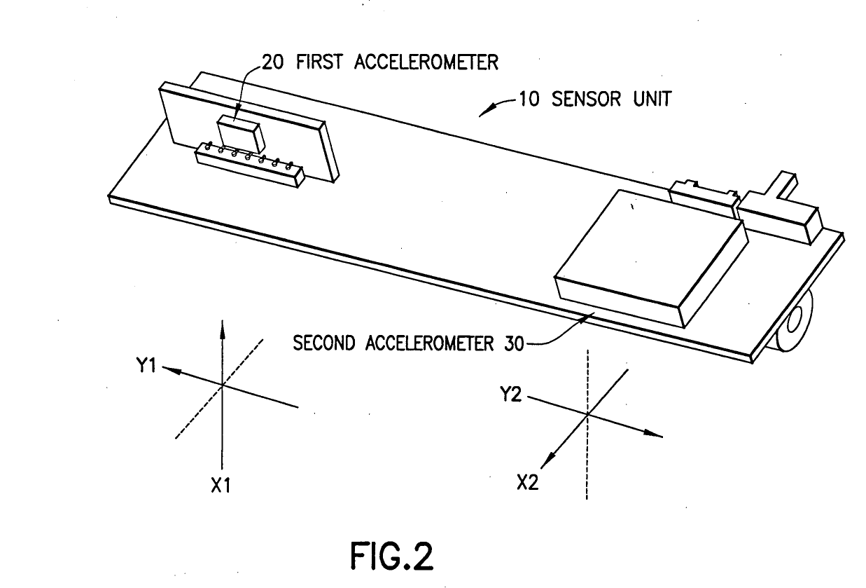

In the present embodiment, as shown in FIG. 2, the accelerometers 20, analog-to-digital converter 40, the sensor processor 50, the transmitter 60, and the sensor firmware 65 are housed in a single sensor unit 10. The sensor unit 10 attaches to a movable object, which is a golf club 70 in this embodiment. The sensor unit 10 is communicatively coupled to the user station 90, via any wired or wireless transmission, such as a serial connector, USB cable, wireless local area network and the like, utilizing essentially any type of communication protocol, such as Bluetooth Ethernet, and the like. Although two-way communication is not required for all embodiments, the transmitter 60 is a transceiver 60 configured to allow two-way communication of data between the sensor unit 10 and the user station 90 (data can be sent from the sensor unit 10 to the user station 90 and data can be sent from the user station 90 to the sensor unit 10). The sensor firmware 65 is configured to listen for command data sent from the user station 90 to the sensor unit 10, which requests the sensor unit 10 to send data to the user station 90. Additionally, the aforementioned components included in the sensor unit 10 may be coupled to one another via any wired or wireless transmission, utilizing essentially any type of communication protocol.

In alternate embodiments, the sensor unit 10 and a dongle unit, each house a wireless transceiver 60. The dongle unit may plug into the USB or serial port of the user station 90 to allow wireless two-way communication of data between the sensor unit 10 and the user station 90. Additionally, the sensor unit 10 may house a transmitter 60 and the dongle unit may house a receiver to allow wireless one-way communication of data from the sensor unit 10 to the user station 90.

The user station 90 is a computing device—a personal computer (PC) having a mouse in the present embodiment, although in alternate embodiments other processors may be used, such as a personal digital assistant (PDA), hand-held game device, web-enabled cellular telephone, laptop computer, home entertainment system (such as those offered by Nintendo of America Inc. and Sega Corporation), video game console in communication with a monitor or television and the like, having the ability to accept input data from a mouse controller and having the ability to run a video game or computer application, such as a training simulation, requiring mouse controller input data. Additionally, in alternate embodiments, the user station 90 may have associated therewith any other type of input device, such as a joystick, paddle, keyboard, or any other type of game controller input and the like, and may have the ability to run a video game or computer application requiring input device data from any of the aforementioned input devices and the like.

The driver software 80 running on the user station 90 is configured to process the digital signal representative of the movement of a moving object received from the sensor unit 10 and convert the digital signal into input device data that can be used to control the movement of game character in the video game or computer application running on the user station 90. In alternate embodiments, the computer application may reside on a machine other than the user station and be accessible to the user of the system via a network, such as the Internet, local area network, cable television, satellite television, and the like.

In the present embodiment, the moving object is a golf club 70 and the digital signal received by the driver software 80 from the sensor unit 10 is a digital signal representative of the acceleration and angle of a swinging club 70. In the present embodiment, the digital signal received from the sensor unit 10 is converted into mouse controller input data. However, in alternate embodiments, the digital signal received from the sensor unit 10 may be converted into other types of input device data, such as joystick, paddle, keyboard, or any other type of game controller input data, and the like, that may be used to control the movement of game character in the video game or computer application running on the user station 90. In the present embodiment, the driver software 80 has a user interface associated therewith for communicating visually and/or audibly with the user, including, but not limited to, receiving user inputs, configuring parameters, logging data, displaying captured data, selecting a port from which to read data, and setting a mode for a left-handed or right-handed golfer.

The system of the present embodiment is used to provide input to any commercial off-the-shelf computer or other video game or computer application capable of using data from an input device, including those simulating the sport of golf, such as that offered by Microsoft Corporation under the trademark LINKS2003, by Electronic Arts Inc. under the trademark TIGER WOODS PGA TOUR 2003, as well as those simulating other sports and scenarios, such as baseball, tennis, soccer, volleyball and hockey. In the present embodiment the sensor unit 10 is attached to a golf club 70. However, in alternate embodiments, the sensor unit 10 may be attached to any other type of moveable object including, a piece of sporting equipment (such as a baseball bat, tennis racket, hockey stick) or may be attached to the user themselves (such as the user's arm or leg, via an arm or leg band having a material, such as velcro) to measure data to convert to mouse controller movement to play a video game or computer application, such as a training simulation.

More specifically, in the present embodiment, the system is designed to allow a user to capture a more realistic feeling of playing golf with the LINKS2003 golf game, by choosing to use a golf club 70 as the input device to a golf video game, instead of the mouse controller, to control the movement of the game characters of the video game, such as the swing of the golf club 70 and, consequently, the movement of the golf ball (path, direction, speed, etc.). The sensor unit 10 attached to the golf club 70 measures the acceleration and angle of the user's swing and produces mouse controller input data representative of the user's swing to be utilized by the video game to control the aforementioned game characters. Thus, the sensor unit 10 is an input device that is separate and distinct from the input device—the mouse—that the video game is designed to respond to. By translating or converting the sensor output signal into the format of the mouse controller, the system replicates or simulates the mouse controller data. Notably, when the format of the translated sensor signal is described to be the same as that of the controller input data, such as mouse controller data, it is to be understood that exact identity of format need not be accomplished, as the description is meant to encompass identity only to the degree required for the user station (and any necessary software) to use the translated sensor signal. Because the system functions independently of the video game and the conversion to mouse controller input data occurs prior to the input of swing data to the video game, the video game receives the mouse controller input data unaware of use of the golf club 70, sensor unit 10, or any prior conversion of data. In this manner, the system of the present embodiment may be utilized for any golf video game that is designed to use mouse controller input data, without the necessity of any additional coding to the video game. In alternate embodiments, however, the translation of movement data into mouse, or other controller, input data may be incorporated into the applicable video game or other computer application.

Having generally described the components of the present embodiment, each component will now be described in greater detail.

As illustrated, the sensor unit 10 houses the first and second accelerometers 20, the analog-to-digital converter 40, the sensor processor 50, and the transceiver 60. The sensor unit 10 is attachable to the shaft of any conventional golf club 70 by any known or developed means, including those permanently and temporarily attached. In the present embodiment, a Velcro hook on the curved bottom of the sensor unit 10 is wrapped in a Velcro loop on the shaft of the club 70 to attach the sensor unit 10 to the club 70. Another velcro hook/loop combination is used to further secure the sensor unit 10 onto the shaft of the club 70. In alternate embodiments, the sensor unit 10 is molded plastic having deformable clips molded therein for receiving the golf club 70. In further alternate embodiments, the means for attaching the sensor unit 10 to the golf club 70 may be clasps, straps, loops, rings, fasteners, velcro, and the like. Preferably, the sensor unit 10 is attached near the bottom third of the club 70 to be close to head of the club 70, which is the point at which the most accurate acceleration and angle of the user's swing can be measured. However, in alternate embodiments, the sensor unit 10 is housed directly within the moveable equipment, such as within a golf club 70, hockey stick, or tennis racket.

As shown in FIG. 2, the sensor unit 10 includes a first accelerometer 20 and a second accelerometer 30, each configured to measure acceleration data and angle data in two directions. In the present embodiment, the dual-axis accelerometers offered by Analog Devices Inc. under model number ADXL202 are used, although in other embodiments other types of accelerometers may be used, such as the ADXL210. The first accelerometer 20 is configured to measure acceleration data and angle data in the x1 and y1 axes. The second accelerometer 30 is configured to measure acceleration data and angle data in the x2 and y2 axes. In the present embodiment, the accelerometers 20 are positioned orthogonal to each other, although other configurations are possible. The accelerometers 20 should also be positioned as close as possible to each other to achieve the most accurate measurement of acceleration and angle data.

The analog-to-digital converter 40 is communicatively coupled to the accelerometers 20 and converts the analog signal representative of the acceleration and angle of the swing produced by the accelerometers 20 to a digital signal representative of the acceleration and angle of the swing.

The sensor processor 50 is communicatively coupled to the analog-to-digital converter 40 to receive the digitized acceleration and angle data. This sensor processor receives the data, assembles it into data frames and communicates it to the transceiver 60. Each data frame contains measurements of acceleration data and angle data at a specific point in time during a swing.

The transceiver 60 is communicatively coupled to the sensor processor 50 and the sensor firmware 65 communicates the digital signal representative of the acceleration and angle of the swinging club 70 to the user station 90. The transceiver 60 may also receive command data from the user station 90.

The sensor firmware 65 is communicatively coupled to the transceiver 60 and sensor processor 50 and continuously listens for command data sent from the user station 90 to the sensor unit 10 (when turned on), which requests the sensor unit 10 to send data to the user station 90, such as a request for calibration data (described later in the application). When the sensor firmware 65 recognizes that command data is being received by the sensor unit 10, via the transceiver 60, the assembly and transmission of data frames by the sensor processor 50 to the sensor unit 10 is temporarily halted, to allow the requested information to be sent to the user station 90.

In the present embodiment, the sensor unit 10 (when turned on) continuously communicates the acceleration data and angle data in the form of data frames to the data buffer of the serial port located in the operating system on the user station 10. The data frames are communicated to the data buffer at a rate of 100 data frames per second, although in alternate embodiments that rate may be higher or lower. The driver software 80 retrieves the data frames stored in the data buffer in the form of data blocks. Each data block includes one or more data frames. The number of data frames in each data block depends on the driver software 80, operating system, and the user station 90. Each data frame consists of an array of data containing the following values:
acc_x1, acc_y1, acc_x2, acc_y2, ang_x1, ang_y1, ang_x2, ang_y2

In each data frame, the term “acc” represents acceleration, the term “ang” represents angle, the numbers 1 and 2 represent the corresponding accelerometer 20, and the letters x and y represent the corresponding axis of measurement (for example, variable acc_x1 represents the acceleration data in the x axis for the first accelerometer 20.)

In each data frame, the acceleration data for acc_x1, acc_y1, acc_x2, and acc_y2 is measured directly from the corresponding accelerometers 20. Each accelerometer 20 may also be used as a dual axis tilt sensor to measure angle data. In each data frame, the angle data for ang_x1, ang_y1, ang_2, and ang_y2 is computed by the sensor firmware 65 residing on the sensor unit 10 using data received from the corresponding accelerometer 20. In the present embodiment, the angle data is output by the accelerometer 20 encoded as Pulse Width Modulation (“PWM”) data, although different accelerometers may output the data differently.

The accelerometers 20 use the force of gravity as an input vector to determine orientation of an object in space. An accelerometer is most sensitive to tilt when its sensitive axis is perpendicular to the force of gravity (parallel to the Earth's surface). At this orientation, sensitivity to changes in tilt is highest. The reference point for the angle of the club 70 is calibrated at the factory, preferably to be 1 g where g represents a unit of gravity (−1 g when parallel to the Earth's surface in an opposite orientation).

In general, when each accelerometer 20 is oriented on an axis parallel to the force of gravity, near its 1 g or −1 g reading, the change in calculated angle per degree of tilt is negligible. As each accelerometer's 20 orientation approaches an axis perpendicular to the force gravity, the relative sensitivity of the calculated angle per degree of tilt becomes greater. By utilizing the change in output acceleration for x and y axes of each accelerometer 20, it is possible to calculate the angle data for x and y axes of each accelerometer 20 and the degree of orientation of the golf club 70 with respect to the Earth's surface. The relationship between the output acceleration and the degree of orientation for accelerometers 20 are typically known, and, if not, can be determined by routine testing. It has been found that in the present embodiment, generally, the angle data is useful only when the sensor unit 10 is in static status, because when the sensor unit 10 is in motion, the angle data is inaccurate because the movement is based on a combination of gravity and the user-induced motion. Accordingly, the present invention utilizes angle data primarily when the club 70 is in a static or slow moving state.

In the present embodiment, the driver software 80 receives the calibration data from the particular sensor unit 10 being used with the system in order to more accurately convert the acceleration and angle data received from the sensor unit 10 into mouse controller movement data. The driver software 80 running on user station 90 sends a request for the retrieval of calibration data to the sensor unit 10 (at any time when the sensor unit is turned on). The sensor firmware 65, listening for command data, recognizes the request for the retrieval of calibration data from the user station 90. The sensor firmware 65 instructs the sensor processor 50 to temporarily halt the assembly and continuous transmission of data frames to the user station 90 and retrieves the calibration data for each sensor 20 requested by the driver software 80. The calibration data for each sensor 20 is sent, via the transceiver 60, to the driver software 80 and used by the driver software 80 to determine the proper mouse controller movement data. Without the proper calibration data for each sensor 20, the driver software 80 would not have a proper reference point at which to correctly interpret the acceleration and angle data from the sensors and would result in simulating mouse movement that is not properly representative of the user's swing.

Additionally, in alternate embodiments, a data frame may be organized in a variety of manners having one or more of the aforementioned variables or additional variables to allow for the storage of angle and/or acceleration data and/or additional measurement data that may be calculated by other types of sensors, such as turn rate and direction, as calculated by a rate gyro.

Persons of skill in the art will recognize that, although the above-referenced system components are discussed and shown as being housed in a singular sensor unit 10, as a matter of design choice, any number of system components may be housed in separate units or combined into one or more system components or units to be utilized within the scope of the present invention. In alternate embodiments, multiple sensors or sensor units may be spaced at different points along the moveable object to better measure the position of the moveable object. Also, in alternate embodiments, the accelerometers 20 are configured to directly output a digital signal, obviating the need for an analog-to-digital converter 40. Additionally, although in the present embodiment the sensor unit 10 attaches to a golf club 70, in alternate embodiments, the sensor unit 10 may attach to any other type of moveable equipment that could be used as an input device for a user station, including, but not limited to, a baseball bat, a hockey stick, tennis racket, and the like. Further, although in the present embodiment the data received from the sensor unit 10 is converted to mouse controller input data, it should be understood that the data received from the sensor unit 10 may be converted into any type of input device data that is utilized by a video game or simulation on a user station 90.

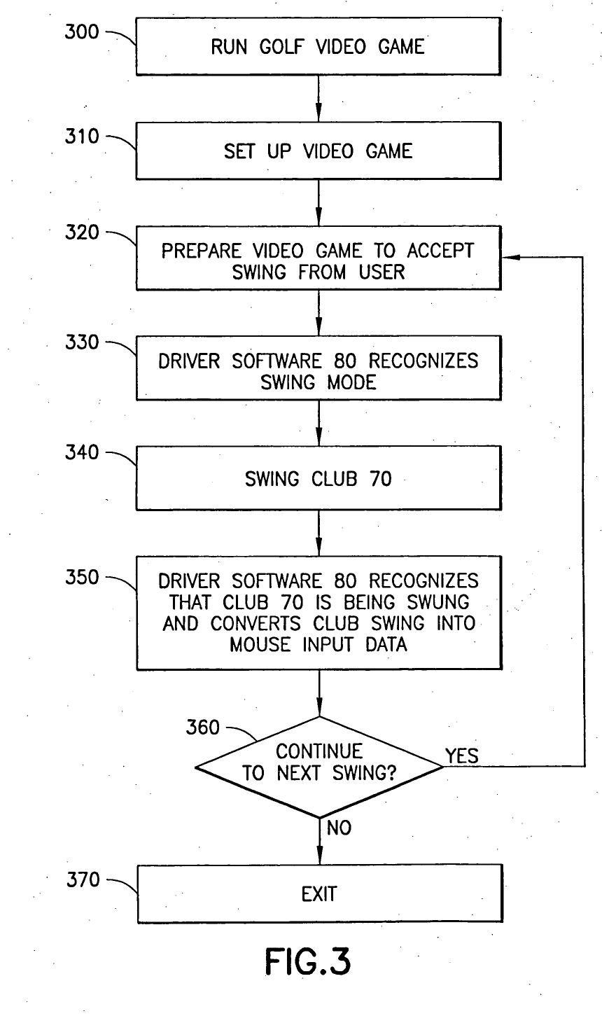

Having described the components of the present embodiment, the operation thereof will now be described in greater detail. The process for using a device and software to play a golf video game according to one embodiment of the present invention will now be described with reference to FIG. 3.

In step 300, the user loads or runs a golf video game, such as those identified above, and the driver software 80 on a user station 90. In step 310, the user sets up the video game according to the game's instructions, such as configuring the game to play in real-time swing mode in LINKS2003. In step 320, the user starts the video game, preparing the game to accept input data to control the movement of the video game characters.

In step 330, driver software recognizes the type of swing mode that has been selected by the user on the video game, for example (1) full swing, (2) chipping, or (3) putting, to configure the proper conversion of acceleration and angle data into mouse controller input data for the swing. In many golf video games, the amount of mouse controller movement necessary to hit the golf ball a certain distance will vary based upon the type of swing mode. For example, a long putt may require a relatively large amount of mouse controller movement similar to a long drive on a video game; whereas a long putt may require only slight club movement as compared to a drive using a golf club 70. Therefore, in certain embodiments, the driver software 80 accounts for this change by being aware of the proper conversion rate of the acceleration and/or angle data of the user's swing into mouse controller input data to be used by the particular video game.

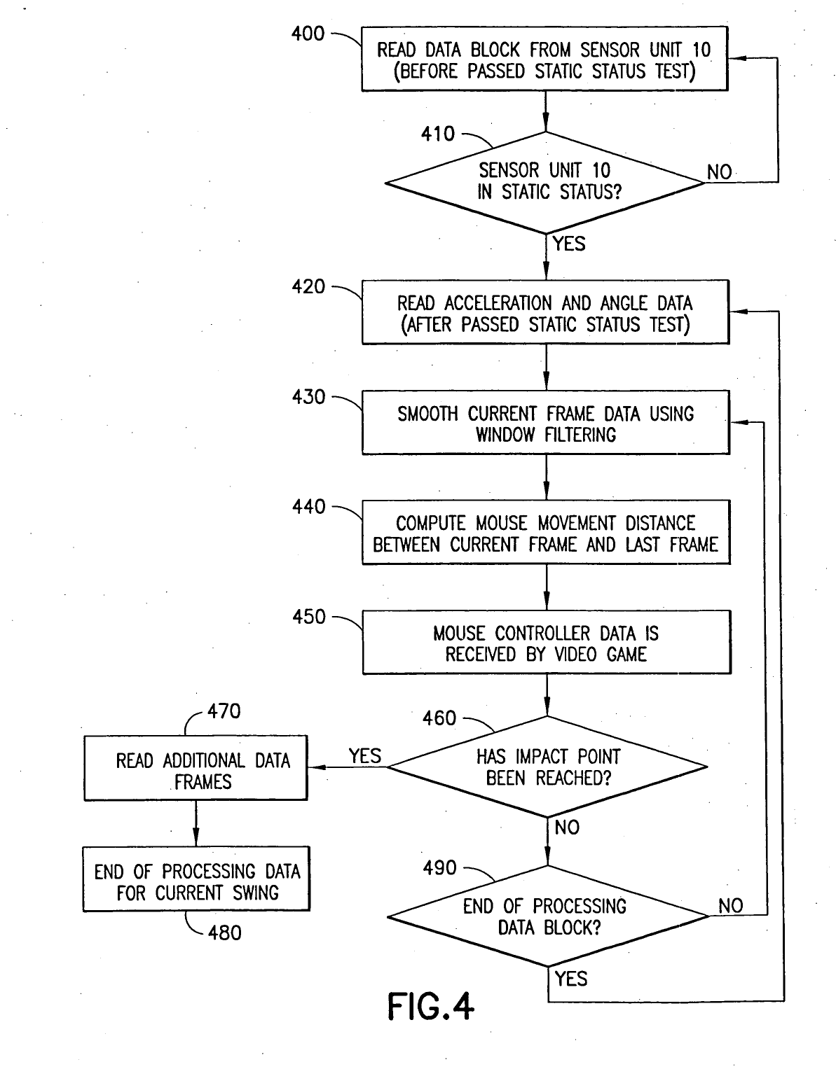

In step 340, the user swings the golf club 70, having the attached sensor unit 10 of the present embodiment. In step 350, the driver software 80 recognizes that the golf club 70 is being swung by the user, via the process described in greater detail herein in FIG. 4. In step 360, the user determines whether to continue to the next swing as is typical in playing the game. If the user determines to continue to the next swing, the processes returns to the user preparing the system to accept the next swing input (step 320). If the user determines not to continue to the next swing (for example, where the game has ended or the user has chosen to quit the game), the process ends (step 370).

As noted above, the driver software 80 converts the accelerometer data into mouse controller input data for simulating a user's movement of the mouse. The process for simulating mouse controller movement according to one embodiment of the present invention will now be described in greater detail with reference to FIG. 4.

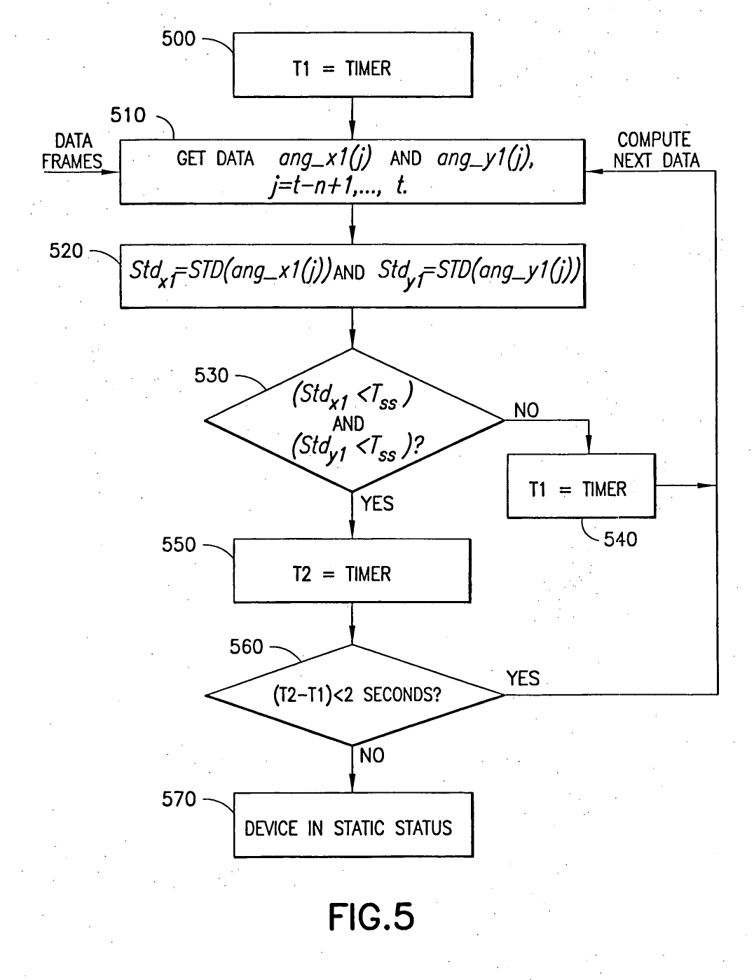

In step 400, the driver software 80 reads a data block having one or more data frames from the data buffer to determine whether the sensor unit 10 is in static status. In step 410, the driver software 80 determines whether the sensor unit 10 is in static status. To determine whether the sensor unit 10 is in a static state, namely, when the user holds the golf club 70 relatively still prior to beginning to swing, the driver software 80 reads the acceleration and angle data from sensor unit 10 in the data buffer 10 to determine if the acceleration and angle data indicate movement below a certain threshold. This determination is described in greater detail below with reference to FIG. 5. If it is determined that the sensor unit 10 is not in static status, in step 410, the driver software 80 reads the next data block from the sensor unit 10 in step 400, waiting for the club 70 to be in static state.

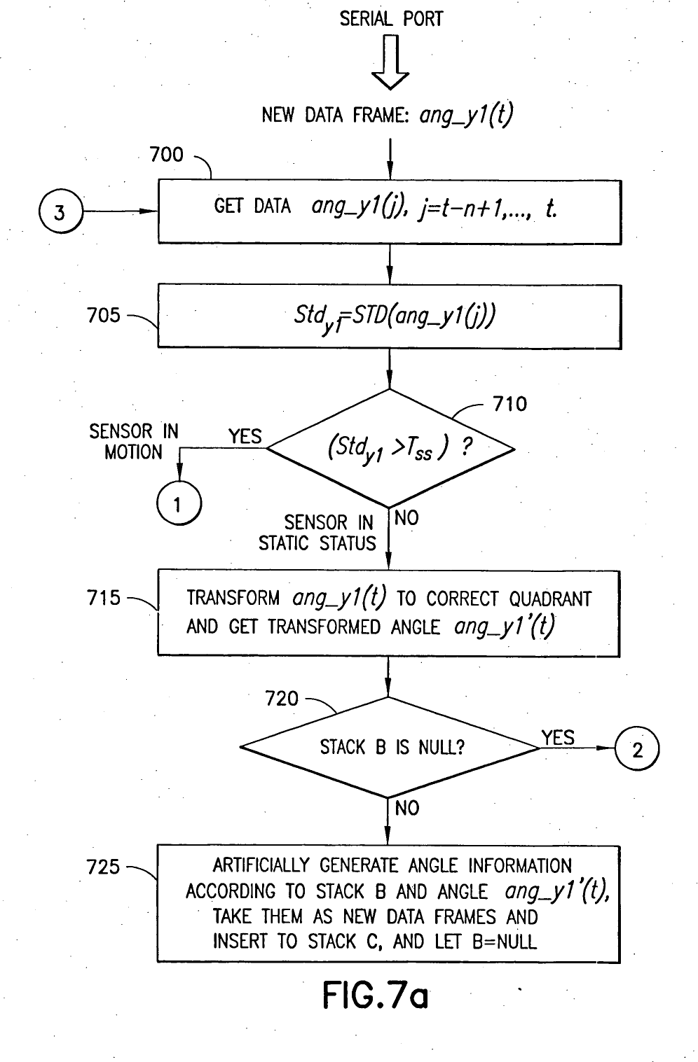

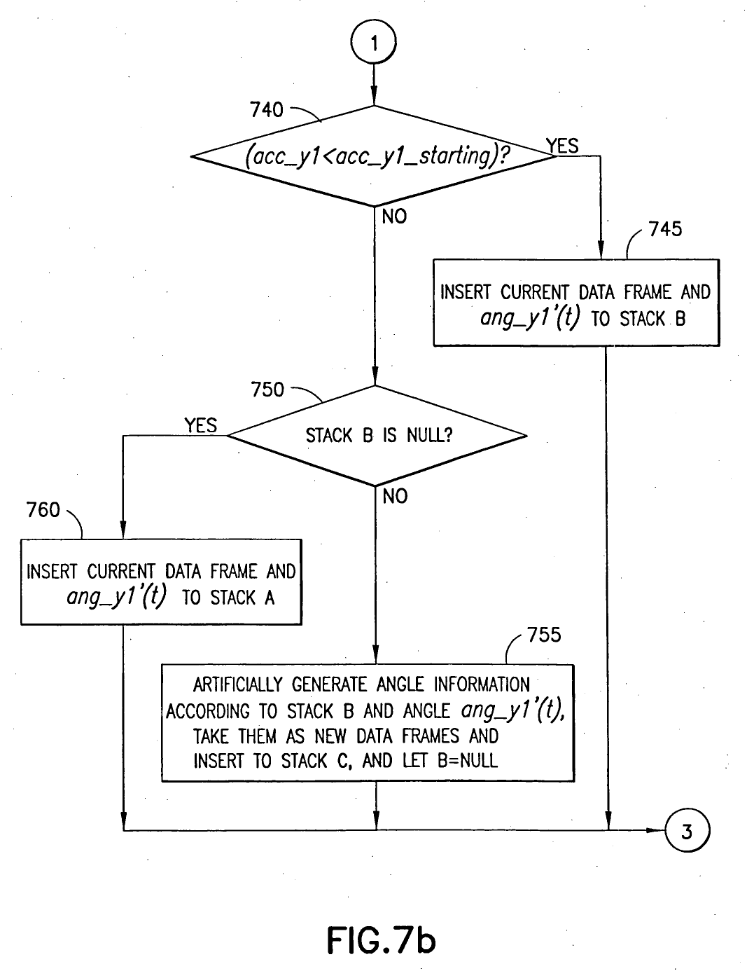

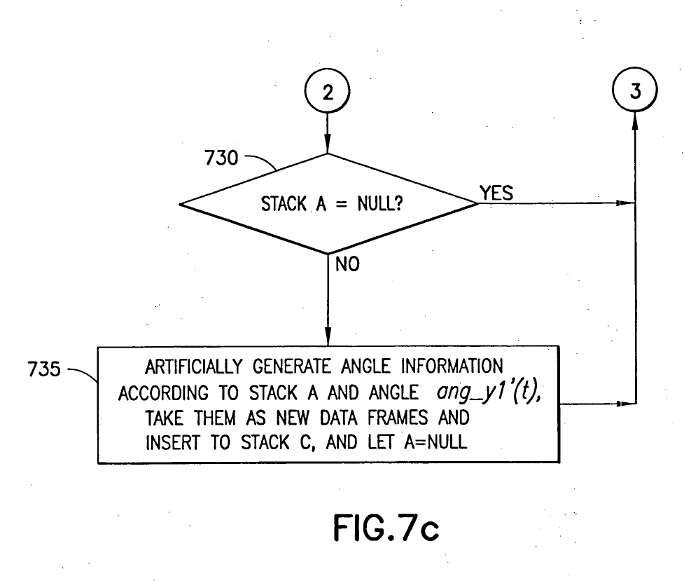

If it is determined that the sensor unit 10 is in static status, the driver software 80 reads the data block, in step 420, to determine the acceleration data and angle data representative of the user's swing. In step 430, the driver software 80 uses window filtering to smooth the current data frame in the data block to filter out the noise resulting from unintentional movement of the golf club 70. In step 440, the driver software 80 converts the filtered acceleration data and angle data to mouse controller input data by computing the incremental mouse controller movement distance between the current data frame in the data block and the prior data frame in the data block. As described in greater detail below with reference to FIG. 7, the driver software 80 translates actual club movement, as measured by the received acceleration and angle data into mouse controller movement data.

In step 450, the mouse controller input data that is representative of the user's swing is received, as if directly from the mouse controller, by the video game software running on the user station 90 to control the movement of a game character in the video game running. In step 460, the driver software 80 determines whether point of impact has been reached. The driver software 80 determines whether the point of impact has been reached by utilizing delayed processing. Following the determination that the sensor unit 10 is in static status, the driver software 80 processes data frames in real-time or substantially real-time until the driver software 80 detects a reading of valid angle data following the acceleration due to the backswing of the club 70 by the user (This generally occurs as the user pauses at the top of his backswing prior to his downswing). Following recognition of valid angle data, as described herein, the driver software 80 continues to process the data frame, but in a delayed format, so that the driver software 80 can determine whether the highest acceleration for the swing has been reached, signaling the point of impact. The delay in processing should be as long as necessary to ensure that the highest acceleration had been reached and the acceleration is now decreasing due to the follow through of the golf swing. If driver software 80 determines that point of impact has been reached, in step 460, then driver software 80 continues to read data frames until angle data shows for the golf club 70 is equal to 20 degrees past the angle data at the point of impact in step 470, and then there is no additional processing of data for current swing and the subprocess ends in step 480. The driver software 80 may be configured to continue reading data frames until the angle data for the golf club 70 is greater than or less than 20 degrees. If driver software 80 determines that point of impact has not been reached, in step 460, then the driver software 80 determines whether the current data block includes another data frame that has not been processed for the user's swing, in step 490. If it is determined that all data frames have not been processed for the current data block in step 490, then driver software 80 reads the next data frame and return to step 430. If it is determined that all data frames have been processed for the current data block in step 490, then process returns to step 420 and driver software 80 reads the next data block.

Having generally described the process of converting swing data to mouse data in the present embodiment, each step in the process will now be described in greater detail.

The process for reading a data block from the sensor unit 10 according to one embodiment of the present invention will now be described. The driver software 80 reads a data block having one or more data frames from the sensor unit 10 to determine whether the sensor unit 10 is in static status. A timer of the driver software 80 is set to allow the driver software 80 to read a data block from the data buffer of the serial port of the user station 90. The timer's interval is preferably set at 200 ms. The data buffer of the driver software 80 for the serial port communication is preferably large enough for 100 data frames to be read by the driver software 80. In alternate embodiments, the timer's interval may be greater or less than 200 ms, and the data buffer may allow for greater or less than 100 data frames to be read by the driver software 80 at one time, as appropriate for the particular application.

The process for determining whether the sensor unit 10 is in static status according to one embodiment of the present invention will now be described in greater detail. The driver software 80 determines whether the sensor unit 10 is in static status. The sensor unit 10 is considered to be in static status when the golf club 70 is being held at a relatively steady position, in the present golf embodiment, at the bottom (prior to swing) or top (pause following backswing) of the user's swing. If the driver software 80 determines that the sensor unit 10 is in static status, the sensor unit 10 is prepared to measure the acceleration data and angle data of the user's next swing. The driver software 80 embodies appropriate algorithms to be used to convert the acceleration and angle data to mouse controller input data, as described herein and one or more audible or other perceptible signals, such as beeps, lights, or voice commands, will occur to alert the user that he or she may now swing the golf club 70.

The number of audible signals depends on the type of swing mode that has been set by the user prior to his or her swing. There are three swing modes that may be selected by the user: (1) full swing; (2) chipping; and (3) putting. The number of audible signals for each type of swing mode are one, two, and three, respectively. In alternate embodiments, other manners of alerting the user as to the status or mode of the golf swing may be utilized, such as a voice command or visual signal (e.g. a group of one, two and three flashes repeated) displayed on the user station 90. The driver software 80 is configured to process the acceleration data and angle data received from the sensor unit 10 using a different method depending upon the type of swing mode that has been set by the user prior to his or her swing. A detailed explanation of the methods employed to process the acceleration data and angle data received from the sensor unit 10 and are described herein.

If the driver software 80 determines that the sensor unit 10 is not in static status from the current data block, the driver software 80 will read the next data block, continuously repeating the process until the driver software 80 determines the sensor unit 10 to be in static status. During this determination of whether the driver software 80 is in static status, no acceleration data, nor angle data received from the sensor unit 10 is converted into mouse controller input data by the driver software 80.

An exemplary process for determining whether the sensor unit 10 is in static status is shown in FIG. 5. In this example, t is the current time; ang_1(i) and ang_y1(i) represent the angle data at time (i) of the x axis of the first accelerometer 20 and the y axis of the first accelerometer 20 (where i=1, 2, 3, . . . t); n is the window filter size; Tₛₛ is the threshold for STD filtering; and STD( ) is a function of standard deviation. At each time, t, the driver software 80 determines whether the sensor unit 10 is in static status, by reading the acceleration and angle data from the sensor unit 10 to determine if the acceleration and angle data indicate movement below a certain threshold, using the following method. In step 500, the timer is set (T1=Timer). In step 510, the driver software 80 reads the data frames in the current data block and obtains the data ang_x1(j) and ang_y 1), where j=t−n+1, . . . , t. By doing so, the driver software 80 acquires the data in the current window to be filtered. In step 520, the software 80 determines the standard deviation for each axis according to the equations: Stdₓ₁=STD(angₓ1(j) and Std_{y1}=STD(ang_y1(j). In step 530, the software 80 determines whether the standard deviation for each axis (Stdₓ₁, Std_{y1}) is below the defined threshold Tₛₛ ((Stdₓ₁<Tₛₛ) and (Std_{y1}<Tₛₛ)). If the logic statement in step 530 is false, namely the change in movement of the club 70 in either axis is above the threshold, then the timer is essentially reset with the current time (T1=Timer) in step 540, and the process continues to read the next data block in step 510. If the logic statement in step 530 is true, namely that the change in movement during the period is less than the threshold, then the current time is noted (T2=Timer) in step 550. In step 560, determine whether the differences in time between the beginning of the readings and the end of the readings is less than a certain threshold, for example, two seconds (i.e., (T2-T1)<2 seconds). The time period of two seconds represents the amount of time that change in movement must be continuously below the threshold in order for the sensor unit 10 to be considered in static status. In alternate embodiment, the time period can be greater than or less than two seconds. If the logic statement in step 560 is true, then the next data block is read in step 510. If the logic statement in step 560 is false, then the sensor unit 10 is in static status in step 570.

When the driver software 80 determines that the sensor unit 10 is in static status, the sensor unit 10 is prepared to measure the acceleration data and angle data of the user's swing and an audible signal (based on the type of swing mode) will alert the user that he or she may now swing the golf club 70. As the user swings the golf club 70, a data block having one or more data frames of acceleration data and angle data is measured by the sensor unit 10 and processed by the driver software 80 to convert the acceleration data and angle data representative of the user's swing into mouse controller input data via the following processes in the present embodiment.

The process for smoothing the current data frame using window filtering will now be described in greater detail according to one embodiment of the present invention. The acceleration data and angle data read by the driver software 80 from the sensor unit 10 often has noise (jitter) associated therewith that is the result of unintentional movement of the golf club 70. The reasons for such noise may include the shaking of a person's hands, the sensitivity of the accelerometers 20 in the sensor unit 10, and the like. It is desirable to filter out this unintentional noise in order to obtain a more accurate representation of the acceleration and angle data to be processed by the driver software 80.

In the present embodiment, the driver software 80 applies a non-linear technique is applied to filter out noise and smooth the acceleration and angle data in the data frame using a sliding window to a data sequence, such as the exemplary process shown below. In the following example, t is the current time; f(i) is acceleration and/or angle data at time (i) (where i=1, 2, 3, . . . t); n is the filter size; p and y are temporary storage variables; f(t−n to t) represents raw angle or acceleration data; and f(t)=transformed angle or acceleration data. At each time, t, the data is processed as follows:

$$\begin{matrix}1 ) Let p ( 0 to n ) = f ( t - n to t ) ; \\ 2 ) \text{Compute} y ( a ) = p ( a ) - p ( a - 1 ) , where a = 1 , 2 , 3 , … n ; \\ 3 ) Let s = {\sum }_{a = 1}^{t} y ( a ) and {s}_{1} = {\sum }_{a = 1}^{t} \vert y ( a ) \vert ; and \\ 4 ) if ∼ ( s = {s}_{1} or s = - {s}_{1} ) then f ( t ) = f ( t - 1 ) .\end{matrix}$$

It is to be understood that the filtering is optional and that other filtering techniques may be used.

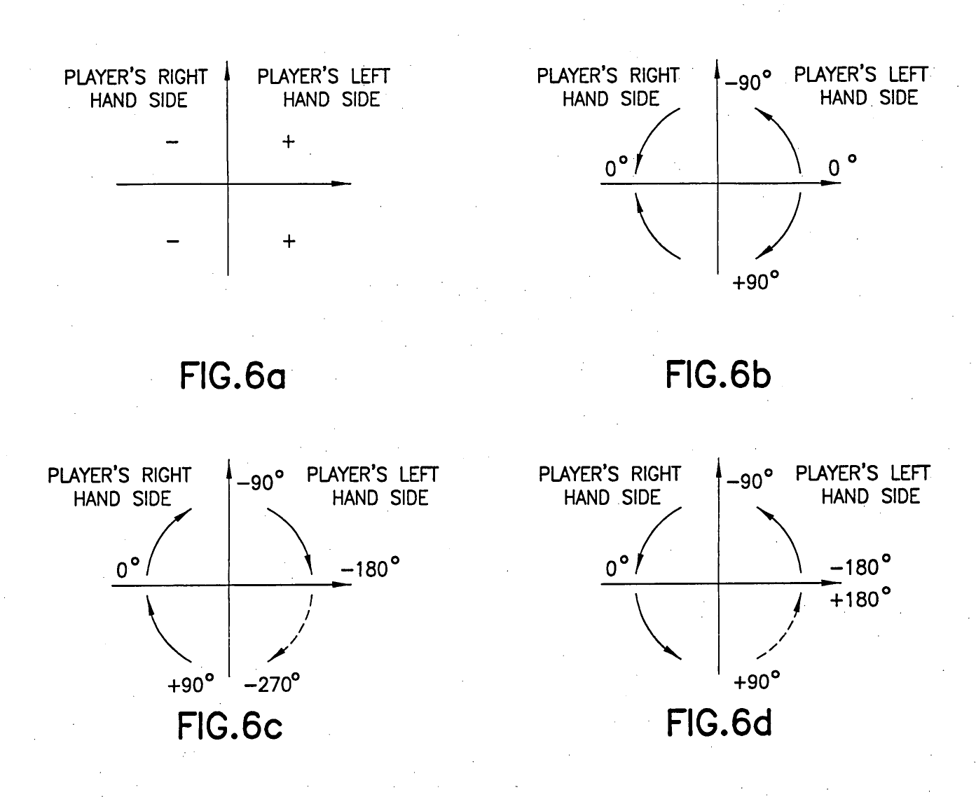

The process for transformation of the unfiltered angle data into filtered angle data according to one embodiment of the present invention will now be described. The particular accelerometers 20 used in the present embodiment measure the angle position in a range of 0 to +/−90 degrees with respect to the vertical direction. Therefore, certain readings may be in one of two quadrants, as illustrated in FIG. 6(b). To more accurately measure the angle position of the golf club 70 and simulate the user's golf club swing, the proper quadrant of the golf club 70 must be determined. The process described below constitutes the method used by the driver software 80 in the present embodiment to determine the proper quadrant of the golf club 70 and calculate the proper angle data to simulate the user's swing.

As described herein, the acceleration data of the golf club swing is measured directly by the accelerometers 20. The first four values in each data frame constitute the acceleration of the golf club swing in the x and y axes of the first accelerometer 20 and the x and y axes of the second accelerometer 30 (acc_x1, acc_y1, acc_{—x}2, acc_y2). The angle data in each data frame is computed by the sensor firmware 65 using PWM data. The last four values in each data frame constitute the angle of the golf club swing in the x and y axes of the first accelerometer 20 and the x and y axes of the second accelerometer 30 (ang_x1, ang_y1, ang_2, ang_y2).

In the present embodiment, the golf club 70 may be positioned in one of four quadrants (90° to 0°, 0° to −90°, −90° to −180°, or −180° to −270°, as pictured in FIG. 6(c). According to the present exemplary depiction, if the golf club 70 is positioned at approximately−180 degrees (i.e., the club 70 being horizontal, parallel to the ground), the user is in full swing position; if the golf club 70 is positioned between−180 degrees and −90 degrees, the user is in ¾ swing position; if the golf club 70 is positioned at approximately−90 degrees, the user is in ½ swing position; and if the golf club 70 is positioned at approximately 0 degrees, the user is in ¼ swing position.

FIG. 6(a) shows the sign changes of ang_x1 and FIG. 6(b) shows the angle changes of ang_y1 in the four quadrants. Compared with other angle data, ang_y1 is relatively stable and not so sensitive to twist. For ang_x1, because of possible twists of the club 70 by players, its value changes even when the sensor unit 10 is in the same position. However, the sign of its value does not change if the accelerometer 20 is not in fast motion. As shown in FIGS. 6(a) and 6(b), the sign of ang_x1 is positive, ‘+’ when the club 70 is swung to the player's left hand side, otherwise, the sign of ang_x1 is negative ‘−’. For ang_y1, if the sensor unit 10 is not in fast motion, its value changes from 90 degree to −90 degree when the position of the sensor unit 10 changes from the bottom to the top (from both sides, left hand side and right hand side). In the present embodiment, in order to map the angle data ang_y1 to the correct quadrants, the value of ang_y1 is defined based on the swing direction, backswing or downswing. FIG. 6(c) shows the value of ang_y1 in different positions based on the backswing direction and FIG. 6(d) shows the value of ang_y1 in different positions based on the downswing direction. The change of ang_y1 determines the mouse controller movement distance. However, the speed of club 70 and distance the golf ball will travel depends on how the particular video game interprets such mouse controller movement.

It has been determined that, in the present embodiment, the angle data is more reliable when the sensor unit 10 is in static status, as opposed to when the sensor unit 10 is in motion, where the angle data is inaccurate. Therefore, the conversion from the golf club swing data (acceleration and angle data) to mouse controller input data will be delayed. In order to improve this conversion rate to substantially real-time, the exemplary process, shown in FIGS. 7(a)-7(c), is used to transform the unfiltered angle data into filtered angle data. In this example, t is the current time; ang_y1(i) represents the angle data in the y axis of the first accelerometer 20 (i=1, 2, 3, . . . t); acc_y1(i) represents the acceleration data in the y axis of the first accelerometer 20 (i=1, 2, 3, . . . t); n is the filter size; Tₛₛ is the threshold for STD filtering; Stack is a data structure for temporarily storing angle data during the transformation process; and STD( ) is a function of standard deviation.

In step 700, the driver software 80 reads the current data frame and obtains the angle data in the y axis at time j, ang_y1(j), where j=t−n+1, . . . , t. In step 705, the software 80 calculates the standard deviation over the filter time period, Std_{y1}=STD(ang_y1(j). Having determined the standard deviation, in step 710, the software 80 determines whether the standard deviation is greater than the threshold value (i.e., whether Std_{y1}>Tₛₛ). If the standard deviation is greater than the threshold, then the sensor unit 10 is deemed to be in motion and the process continues with step 740.

If the standard deviation is equal to or less than the threshold, then the sensor unit 10 is deemed to be in static status and the process continues with the software 80 transforming the angle data, ang_y1(t), into transformed angle data, ang_y1′(t), to reflect the correct quadrant of the club 70 in step 715. Because the particular accelerometers 20 measure the angle position in a range of 0 to +/−90 degrees, certain readings may be in one of two quadrants, as illustrated in FIG. 6(b). This process determines the proper quadrant and transforms the angle data, as received from the accelerometers 20, into angle data reflective of the appropriate quadrant. For example, angle data of −70 could be in either the bottom right quadrant or the upper right quadrant, as illustrated in FIG. 6(b).

In step 720, the software 80 determines whether Stack B is null, or empty. If stack B is not null, then, in step 725 the driver software 80 artificially generates angle information according to Stack B and the transformed angle, ang_y1′(t), takes them as new data frames and insert them into Stack C; Stack B remains null. If Stack B is null, then the driver software 80 determines whether Stack A is null, in step 730.

If Stack A is not null, then, in step 730, then the driver software 80 artificially generates angle information according to Stack A and the transformed angle, ang_y1′(t), takes them as new data frames and insert them into stack C; Stack A remains null. If Stack A is null, then the process returns to step 700 to read a new data frame.

Continuing with step 740, the driver software 80 determines whether the current acceleration in the y axis is less than the acceleration at the beginning of the time period, as stored by the driver software 80 (i.e., acc_y1<acc_y1_starting). If the current acceleration is less than the starting acceleration, then, in step 745, the software 80 inserts the current data frame and transformed angle data, ang_y1′(t), into Stack B, and the process returns to step 700 to read new data frame.

If the current acceleration data is not less than the starting data, then the driver software 80 determines whether Stack B is null in step 750. If Stack B is not null in step 750, then, in step 755, the driver software 80 artificially generates angle information according to Stack B and the transformed angle, ang_y1′(t), takes them as new data frame, inserts them into Stack C, and lets Stack B be null. The process then returns to step 700 to read new data frame. If Stack B is null in step 750, then the driver software 80 inserts current frame data and transformed angle data, ang_y1′(t), into Stack A in step 760, and then the process returns to step 700 to read new data frame.

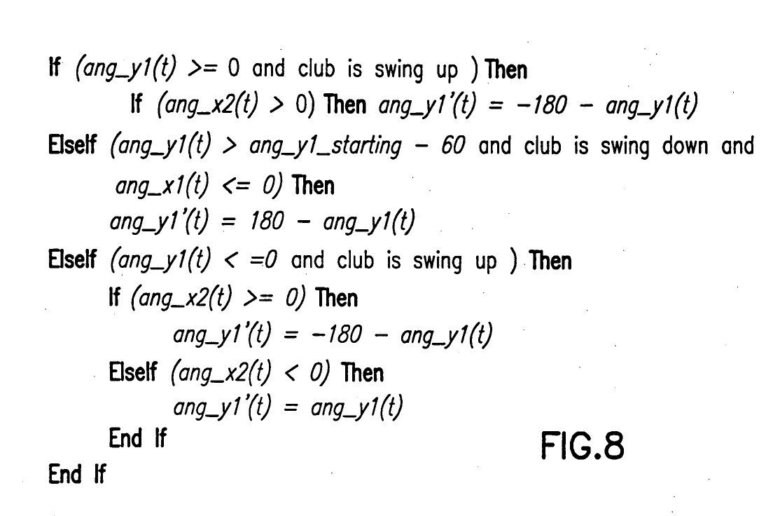

The process for transforming the value of raw angle data into correct quadrant angle data according to one embodiment of the present invention will now be described with reference to the exemplary pseudocode shown in FIG. 8. As illustrated, the driver software 80 determines whether the angle data in the y1 axis is greater than or equal to zero and whether the club 70 is in backswing. The driver software 80 determines whether the club 70 is in backswing by using angle change. If these conditions are satisfied, then if the measured angle data in the x2 axis is greater than zero, the transformed angle data in the y1 axis equals−180 less the actual angle data in the y1 axis. The result is transforming a reading that could be in either the player's left top quadrant or player's left bottom quadrant into the player's left bottom quadrant. Similarly, if the angle data in the y1 axis is greater than the starting value minus 60 degrees, the club swing is determined to be downswing (i.e., moving towards impact) and the x1 angle data is less than or equal to zero, thereby indicating that the club 70 is in the player's left quadrant, then the transformed y1 angle data equals 180 less the actual angle value. The other transformed angle values are calculated as indicated in the FIG. 8.

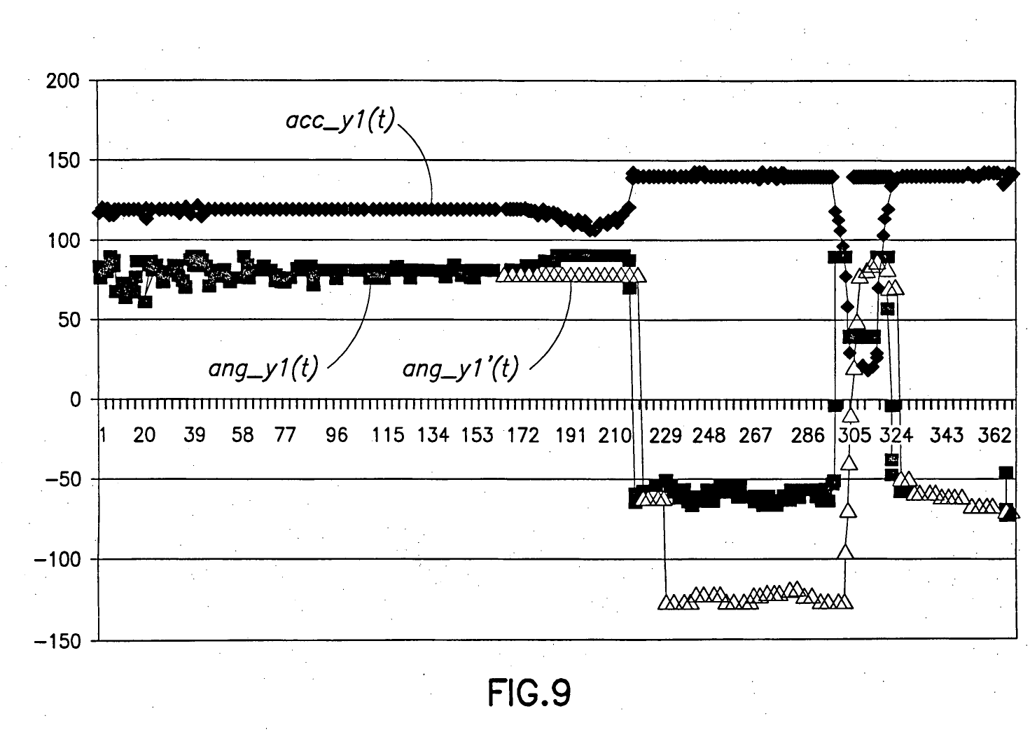

An example of raw angle data, transformed angle data, and raw acceleration data for a three-quarter swing according to one embodiment of the present invention will now be described with reference to the illustrative graph in FIG. 9. The values displayed vertically along the graph represent acceleration values measured in mg (where 1 mg equals one thousandth of the gravitational constant, g). The values displayed horizontally along the graph represent the date frame number within the data block for a swing acc_y1(t) at each data frame is displayed as line 910, ang_y1(t) at each data frame is displayed as line 920, and ang_y1′(t) at each data frame is displayed as line 930. As seen in FIG. 9, from data frame 1-172, acc_y1(t) remains constant at approximately 120 mg (threshold value), which represents the golf club 70 remaining in static position prior to the swing. From data frame 173-210, acc_y1(t) decreases slightly below the static position threshold value 120 mg to approximately 100 mg and then returns to 120 mg, which represents a small increase in acceleration resulting from the back swing of the golf club 70. From data frame 211-300, acc_y1(t) remains constant at approximately 140 mg, which also represents the golf club 70 remaining in static position as the user pauses at the top of their swing. From data frame 301-324, acc_y1(t) decreases drastically below 120 mg to approximately 20 mg and then returns to static position at 140 mg, which represents a large increase in acceleration resulting from the user's swing of the golf club 70 and then the follow through. The lowest point of the decrease, at approximately data frame 310, represents the highest acceleration of the swing and the simulated point of impact of the golf ball. From data frame 325-362, acc_y1(t) remains constant at approximately 140 mg, which represents the golf club 70 paused at the end of the follow through by the user.

As seen in FIG. 9, from data frame 1-165, ang_y1(t) fluctuates slightly as a result of unintentional movement of the golf club 70. At data frame 166, the driver software 80 recognizes that the golf club 70 is in static position as the unintentional movement lessens and begins mapping the ang_y1(t) data to the correct quadrant to obtain ang_y1′(t) as described in FIG. 8. From data frame 166-211, ang_y1′(t) remains constant while the golf club 70 remains in static position prior to the swing and during the back swing. At data frame 212, ang_y1′(t) drops significantly representing the filtering algorithm calculating the quadrant that the club 70 is in using the valid angle data. After this calculation, the algorithm determines that the club 70 is actually in the ¾ swing quadrant and the filtered data is adjusted according to this calculation, from data frames 229-300. From data frames 301-324, acc_y1(t) increases drastically representing the change in quadrant as the user swings the club 70, and then decreases drastically representing the change in quadrant as the user follows through after swinging the club 70.

The process for transforming the angle change of a golf club swing into mouse controller movement distance according to one embodiment of the present invention will now be described.

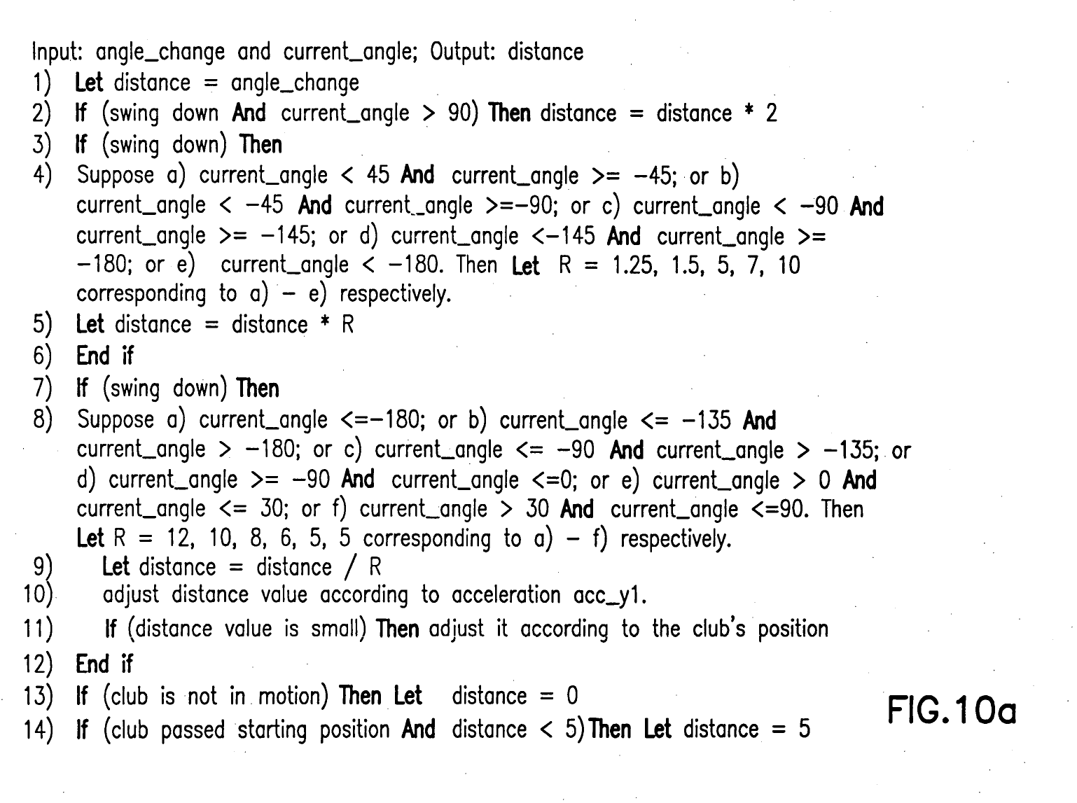

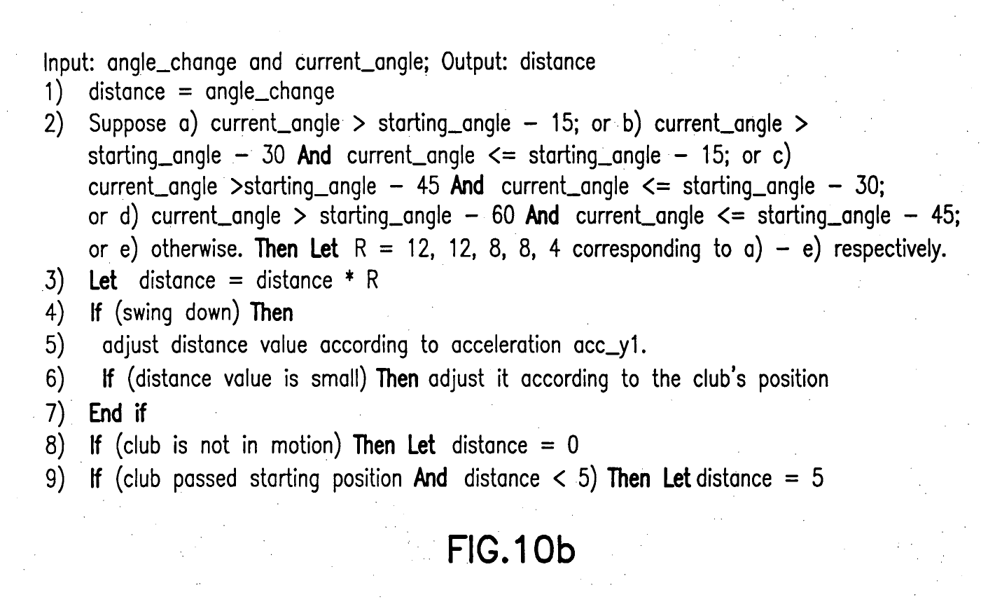

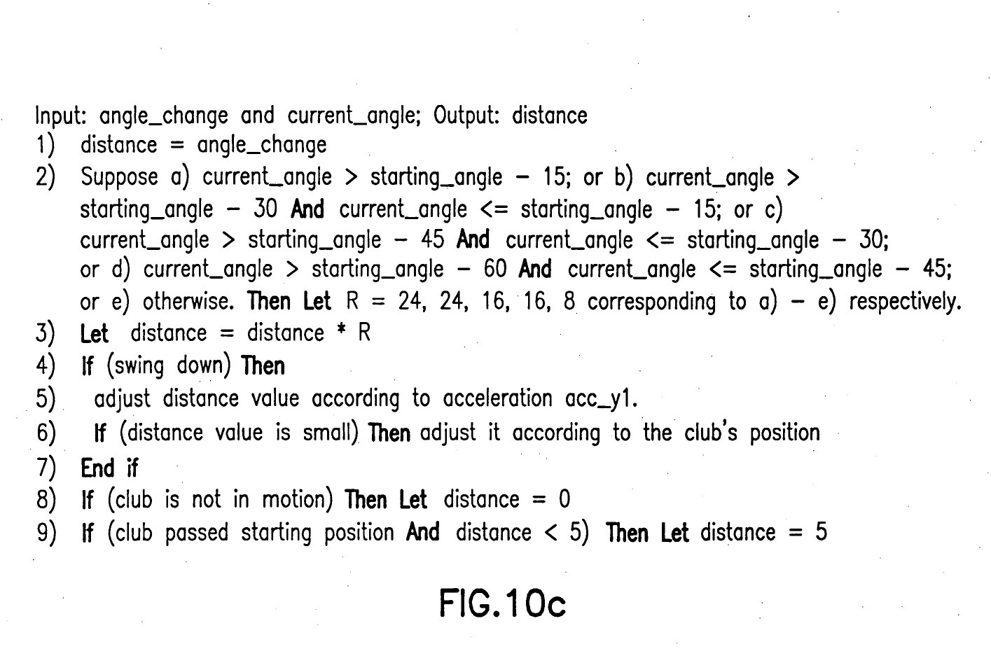

Once raw angle, ang_y1(t), is transformed into correct quadrant angle, ang_y1′(t), the mouse controller movement distance can be computed. The following exemplary processes for transforming (a) full swing; (b) chipping; and (c) putting into mouse controller movement distance are described respectively with reference to the pseudocode in FIGS. 10(a)-10(c).

In these examples, t is current time; and ang_y1′(t) is angle data in the current data frame of the y axis of the first accelerometer 20; ang_y1′(t−1) is angle data in the prior data frame of the y axis of the first accelerometer 20. The mouse controller movement distance between ang_y1′(t) and ang_y1′(t−1) may be mapped based on the swing mode and the position of the golf club 70.

An additional process for transforming the angle change of a golf club putt into mouse controller movement distance according to one embodiment of the present invention will now be described.

A user has to move the mouse a relatively long distance to drive in putting mode for certain video games. However, a user usually moves the club 70 in a short distance for putting. In order to let the user feel more real, in putting mode, it is necessary to move a long distance for a small angle change. The angle changes can be mapped to mouse movement distance directly, as for full swing mode and chipping mode. However, because of the noise in raw angle data, when the player holds the club 70 in static position, there is no guarantee that the angle data has not changed after the window filtering technique, as described earlier, is applied. The following pseudocode represents one possible way to overcome this problem, in which the distance of club movement is equal to the angle change of the club 70 multiplied by a conversion variable, R, which is based on the difference between the current angle and starting angle. In the following pseudocode, the variable, distance, represents mouse movement distance, and the unit of measurement of distance is pixels. The code also determines whether to ignore nominal movements (lines 2-5) so as not to inadvertently hit the ball. Furthermore, if the club 70 passes the starting position, the code assumes the user intended to hit the ball (in line 7) and ensure a minimum distance, for example, five pixels.

Input: angle_change and current_angle; Output: distance

1) distance=angle₁₃ change
2) For last PUTT_DOWN_STABLE_LENGTH frames of angle data (ang_y1), Let k1=the number of angle changes that are greater than 0 and less than 10.
3) For last PUTT_UP_STABLE_LENGTH frames of angle data (ang_y1), Let k2=the number of angle changes that are less than 0 and greater than−10.
4) If (k1=1 Or k2=1) Then distance=0
5) Suppose a) current_angle>starting_angle—15; or b) current_angle>starting_angle—
   And current_angle<=starting_angle—15; or c) current₁₃ angle>starting_angle—45
   And current₁₃ angle<=starting_angle—30; or d) current_angle>starting_angle—60
   And current_angle<=starting_angle—45; or e) otherwise.
   Then Let R=24, 24, 16, 16, 8 corresponding to a)-e) respectively.
6) Let distance=distance*R
7) If (club passed starting position And distance<5) Then Let distance=5

It is to be understood that modifications may be made to the code. For example, the values of R are merely exemplary, as are the ranges of angle data corresponding to such values.

Where the user station 90 is a PC operating Windows based operating system, a Windows API “sendInput” is used to move mouse automatically. The declaration is: Declare Function SendInput Lib “user32.dll” (ByVal nInputs as Long, pInputs As INPUT_TYPE, ByVal cbSize as Long) As Long. The detailed explanation of this API could be found in Microsoft's SDK document, which can be found at http://www.partware.com/ebooks/API/ref/s/sendinput.html.

The mouse controller movement distance computed by the driver software 80 may need to be implemented in multiple incremental movements instead of a single large mouse controller movement to ensure proper simulation of the user's swing. For example, where the acceleration data and angle data representative of the user's swing is converted into a mouse controller movement distance of more than 50 pixels, such a large mouse controller movement distance would not be accurately understood by a video game, such as LINKS2003. Where the mouse controller movement distance computed by the driver software 80 would be too large to be accurately understood by the video game, the mouse controller movement distance is represented by several mouse movement steps. For each different swing mode, the length of the mouse movement step is different. Between every two simulated mouse controller movement s, the driver software 80 should wait some time to allow the operating system of the user station 90 to respond to the last mouse controller movement command. Otherwise, a new SendInput will be triggered and it will stop last mouse controller movement, which let the club 70 in LINKS 2003 not correspond to the real swing. In certain embodiments, a wait time of 10 milliseconds is used for both backswing and downswing.

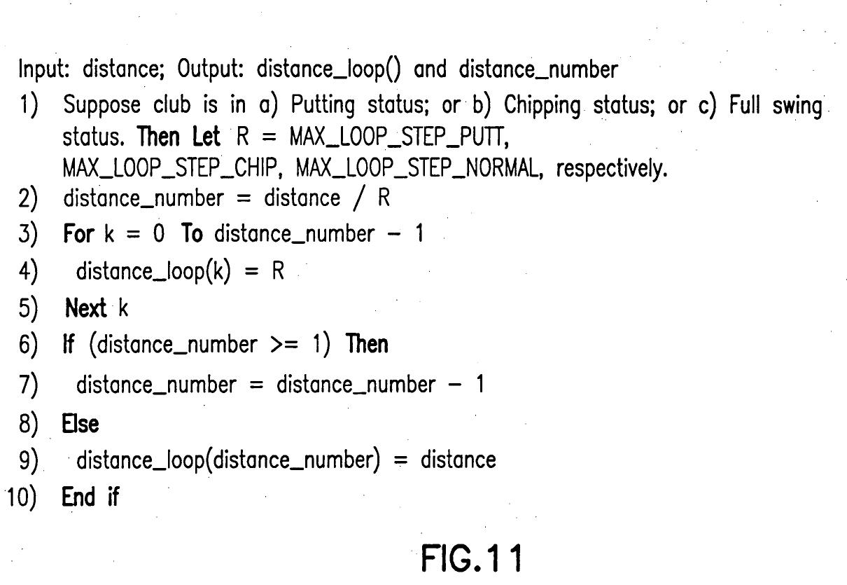

An exemplary process for converting exceptionally large swing data into mouse controller movement data that can be understood by a video game according to one embodiment of the present invention will now be described below with reference to the pseudocode FIG. 11. The acceleration and angle data received from the sensor unit 10 may be converted into mouse controller movement data that is too large for a particular video game to handle at once. Therefore it is necessary to break up the large mouse controller movement data from one large movement to multiple smaller movements. For example a mouse movement of 100 pixels may need to be broken into increments of 25 pixels for a putt or chip, and increments of 50 pixels for a full swing.

Input: distance; Output: distance_loop( ) and distance_number

1) If club is in a) Putting status; or b) Chipping status; or c) Full swing status, then Let R=MAX_LOOP_STEP_PUTT, MAX_LOOP_STEP_CHIP, MAX_LOOP_STEP_NORMAL, respectively.
2) distance_number=distance/R
3) For k=0 To distance_number-1
4) distance_loop(k)=R
5) Next k
6) If (distance_number>=1) Then
7) distance_number=distance_number-1
8) Else
9) distance_loop(distance_number)=distance
10) End If

In further embodiments, the driver software 80 further accounts for club face position, namely open, closed, or square, to determine the angle or direction at which the golf ball would travel following the point of impact. In certain embodiments, each club face position is assigned a particular range of swing speed. When a user swings the club 70, a club face position for the swing is determined based upon the range that encompasses the user's swing speed. In alternate embodiments, the club face direction is determined by an examination of the acceleration components transverse to the direction of motion of the club.

More specifically, in one embodiment, the determination as to the position of the club face is based on the speed of the user's swing at the point of impact: an average speed swing results in a square club face position; a slower than normal swing results in a closed club face; and a faster than normal swing results in an open club face. To determine what is normal for any given golfer/user, the software 80 is trained by the user taking several practice swings. The range of speeds for these practice swings are noted in memory and divided into three ranges, one for each of the three club face positions. In certain embodiments, once the user's swing has been calibrated, the speed of the actual swing is determined as the average of the speed at the point of impact and during two frames immediately following impact, although the value may be taken at fewer or more points in the swing (i.e., frames). For example, using the Analog Devices Inc. ADX1202 dual axis accelerometer, certain golfers would have the following ranges and club face positions for a full swing: if ang_y1 is in the high range of 148-180 mg the club head is in open club face position, if ang_y1 is the middle range of 143-147 mg the club head is in square club face position, and if ang_y1 is in the low range of 120-142 mg the club head is in the closed club face position (mg=one thousandth of the gravitational constant, g). For a chip or putt,: if ang_y1 is in the high range of 131-165 mg the club head is in open club face position, if ang_y1 is the middle range of 126-130 mg the club head is in square club face position, and if ang_y1 is in the low range of 90-125 mg the club head is in the closed club face position. It should be understood that any number of positions may be deemed relevant, including fewer than three or more than three (e.g., different degrees of open or closed position) and the range of speeds can be correspondingly divided into fewer or more subranges. Furthermore, the subranges associated with the positions can be, but need not be, uniform in size.

In alternate embodiments of the present invention, rate gyros may be used as additional sensors to extract rotational motion, in addition to translational motion, to allow for six degrees of freedom. In such embodiments, the six degrees of freedom may include three dimensions to describe the motion of a rigid body through three dimensional space and may include another three dimensions to describe rotational motion.

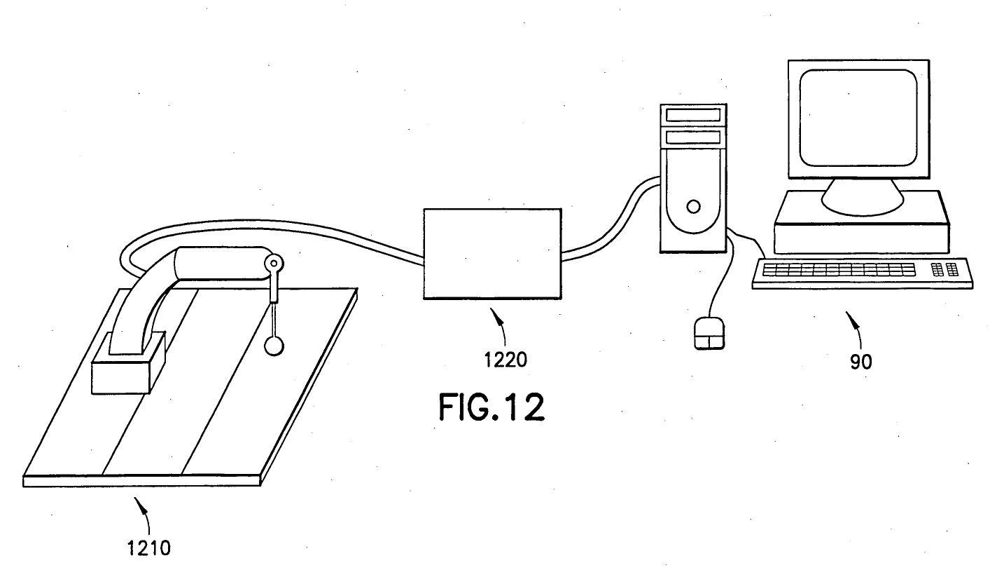

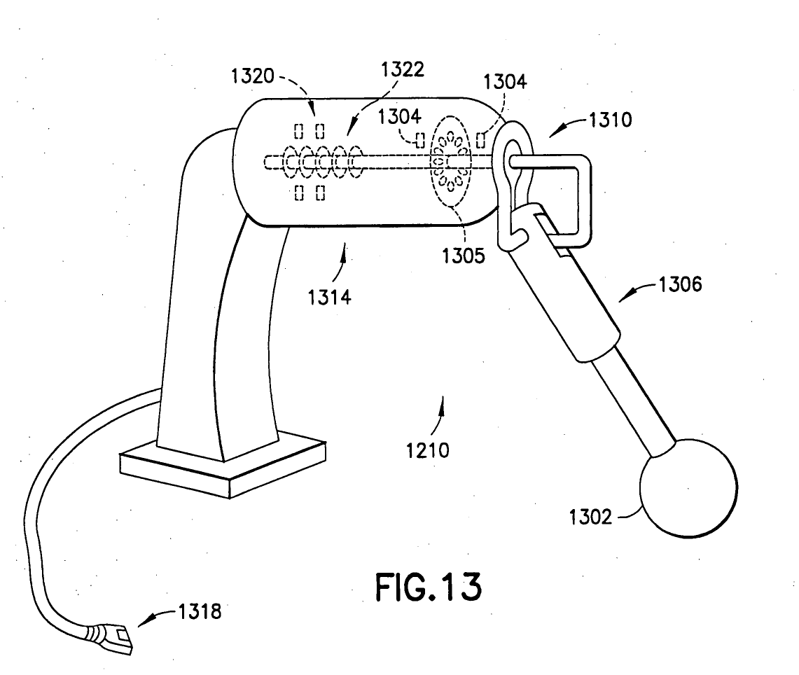

A further embodiment of the present invention utilizing a different sensor in connection with a golf video game or application will now be described with reference to FIGS. 12 and 13. The components used to implement this embodiment of the invention include: a swing arm assembly 1210, a swing arm connector 1220, and driver software 1230. Although the driver software 1230 may run on any type of user station 90, such as a personal computer (PC), video game console in communication with a monitor or television, or other computing device, and can interface with any type of computer or video game application, in the present embodiment the software application runs on a PC and the computer application is a golf video game programmed to use mouse controller input, such as any version of the games noted above.

As discussed in greater detail below, the swing arm assembly 1210 measures ball speed and direction and, therefore, club movement. The swing arm assembly 1210 is in communication with the swing arm connector 1220, which processes the output of the swing arm assembly 1210. The swing arm connector 1220 passes its output to the user station 90, which makes data available to the video game. Although a separate component in the present embodiment, the hardware and/or functions of the connector 1220 may be included in the assembly 1210 or user station 90.

In this embodiment, as shown in FIG. 13, the swing arm assembly 1210 has a simulated golf ball 1302 attached to a shaft 1306 that is able to swing freely around an axel 1310 along an axis of rotation, which is housed in the main body 1314 of the swing arm assembly 1210 and is parallel to the ground. When the golf ball 1302 is struck by a golf club, the golf ball 1302 and shaft 1306 attached thereto rotate the axel 1310 around its axis of rotation. The ball speed, and thus distance, are determined by the rate of rotation. The shaft 1306 is also able to move transverse to the forward direction of rotation, which allows for the measurement of the ball flight angle (e.g., left, right, slice, hook, straight). Although certain embodiments of the invention are described as providing for the measurement of translational motion, such as ball direction or ball flight angle, alternate embodiments of the invention do not require the measurement of translational motion.

More specifically, the swing arm assembly 1210 has three optical emitter/detector pairs within its main body. A first optical emitter/detector pair 1304 is used to determine the rate of rotation of the axel 1310 to which the simulated golf ball 1302 and shaft 1306 are attached. This is accomplished by placing a circular disc 1305 with evenly spaced slots cut in a radial direction along its perimeter and placing this disc between an optical emitter/detector pair. As the disc rotates the light from the optical emitter is periodically interrupted from reaching its mated detector as determined by the width of the slots in the circular disc and by the rate of rotation of the disc. The analog signal from this optical emitter/detector is a pulse train by which the rate of rotation and thus speed can be determined. This analog signal is fed to the swing arm connector 1220 through the RJ45 connector 1318.

Two other optical emitter/detector pairs 1320 are used to determine ball flight direction. The two other optical emitter detector pairs are placed alongside the axis of rotation along an area where the axel has what is in effect a threaded screw 1322. The threaded screw can move laterally between the optical/emitter pairs with the thread of the screws when the ball 1302 is hit other than straight, interrupting the light between mated optical emitter/detector pairs. The timing difference between the two signals originating from these two optical emitter/detector pairs determines how far the main axis of rotation as moved in a transverse direction—i.e., the measure of the angle of deflection of a swing from a straight swing, such as right, left, slice, hook. In alternate embodiments, the axel includes a series of discs concentric with the axel, rather than a threaded screw, that interrupt the detector pairs. As the axel moves laterally, the discs interrupt the detector pairs. The number of interruptions determines, (e.g., is proportional to) the degree of offset from straight. These analog signals are fed to the swing arm connector 1220 through the RJ-45 connector 1318.

The ball flight speed is measured by counting the number of pulses output from the first optical emitter/detector pair as described above occurring within a certain time period. This count is then scaled into units of miles per hour by the microcontroller firmware. In this embodiment, the ball flight speed or tangential velocity, V, is obtained using the following equation:
V=N*(L/R)*(S/T)
where N is the number of pulses counted in time T, L is the length of the shaft to which the simulated golf ball is attached, R is the radius of the circular disk that rotates between the first optical emitter/detector pair, and S is the length of the arc between each slot in the circular disk.

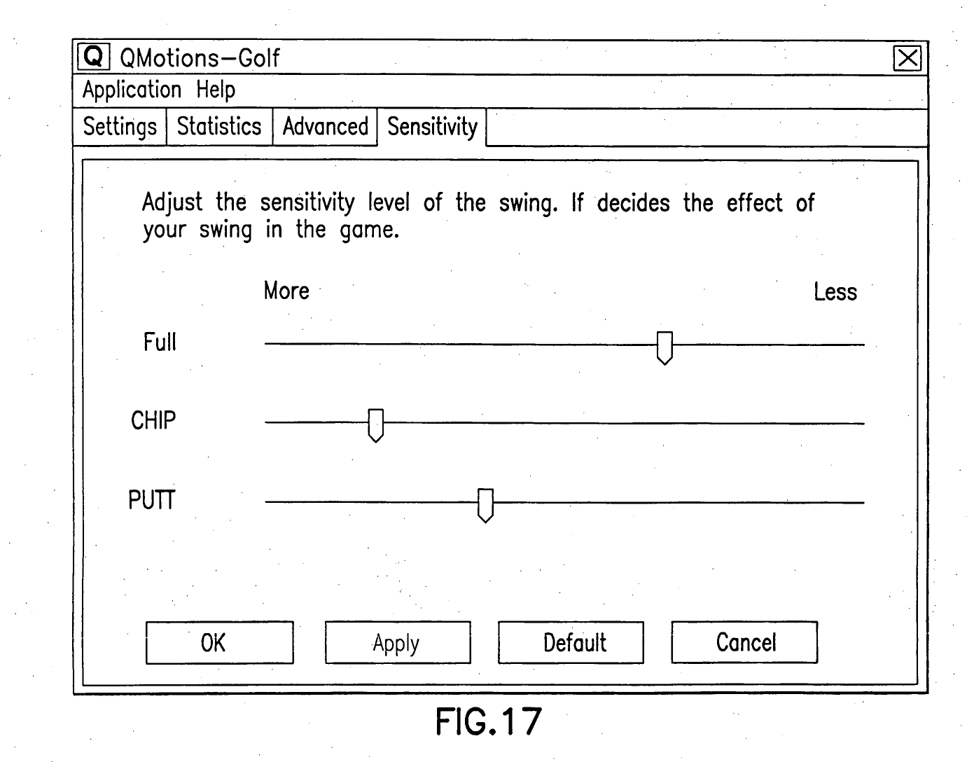

More specifically, the driver software 1230 utilizes the speed and direction information to synthesize mouse translation data. It should be understood that the speed used in the driver software need not be the actual, or real, speed collected from the sensor. Instead, the synthesized mouse data could be an adjustment of the real speed. This kind of adjustment is referred to as “Sensitivity.” Using different sensitivities in the driver software (and in certain embodiments, also in the video game), different players can adjust their feeling of the game personally. According to one embodiment of the present invention, as illustrated in FIG. 17, the user may adjust the sensitivity of how each swing type or mode (full, chip, putt, etc.) will be converted to mouse controller input data to simulate the user's swing, via a graphical user interface provided on the user station 90. Greater sensitivity means that slower club speed (or ball speed in the embodiment discussed below) is needed to result in the same swing in the video game. Less sensitivity means that faster club speed is needed to result the same swing in the video game. There may be a default button so that the user can restore the sensitivity values to predefined values.

Algorithms within the driver software 1230 synthesize mouse movement data based upon the type of mouse motion and/or clicking that would be necessary to drive the video game software to effect a swing that would simulate the actual swing speed and direction as measured by the swing arm assembly 1210. Such algorithms are described above.

In one embodiment, the swing arm assembly 1210 may take the form of a modified product sold under the tradename SWING GROOVER and SWING GROOVER II by Dennco. Such optional modifications made to the SWING GROOVER II assembly include an increased number of slots in the plastic disc which rests between one of the optical emitter/detector pairs. The additional slots are cut into the plastic disc in the area where the axel 1310 would be positioned in a steady state position (i.e, when the ball 1302 is hanging freely and not in motion), thus allowing greater resolution motion detection, which is particularly useful when measuring putts or other small movements. In addition, the SWING GROOVER II may optionally be modified so that the axel 1310 to which the ball swing shaft 1306 is attached with thicker gauge wire. The thicker gauge wire may be used to provide a more stable platform that is sturdier and may reduce the flex of the material pattern which passes through the pair of optical emitter/detector pairs providing angle information. In other embodiments unmodified SWING GROVER or SWING GROVER II swing arm assemblies may be used.

Exemplary implementations of the swing arm assembly are disclosed in U.S. Pat. Nos. 6,257,989 and 5,178,393, both of which are hereby incorporated herein by reference, which implementations may be modified as disclosed above.

In the present embodiment, the ball flight direction is measured within ten (10) degree resolution increments, up to extremes up 30 degrees from straight line motion due to physical limitations of the swing arm assembly 1210; however, other swing arm assemblies, resolutions and maximums are within the scope of the present invention.

Additionally, in alternate embodiments the one or more algorithms contained in the first microcontroller, described herein, may be modified from that of the swing arm assembly described in U.S. Pat. Nos. 6,257,989, so that during slow speed swings, such as those swings that might occur with a putt, direction calculations are not attempted, since direction data may be unreliable during slow speed swings. In alternate embodiments, the system utilized a different direction algorithm and calculations for different swing (or movement) speeds. For example, finer calibration and lower maximums may be employed when in putting mode or during a swing (ball movement) below a predetermined speed. In other embodiments, no direction information is used (i.e., assumes straight ball flight).

The swing arm assembly 1210 is attached through an RJ45 connector 1318 (although other connections may be used) to the swing arm connector 1220. The swing arm connector 1220 accepts the input of analog signals from the swing arm assembly 1210. Through analog and digital processing of the signals from the swing arm assembly 1210, the swing arm connector 1220 computes the speed and direction of the ball. Once speed and direction are computed they are transmitted by standard USB interface to the user station 90, (here a personal computer) on which the video game software is running. The format of data transmission is in accordance with the Human Interface Device (HID) standard, although other formats can be used.

The swing arm connector 1220 accepts three analog signals from the swing arm assembly 1210: one pulse train signal regarding speed (and thus distance) and two pulse train signals regarding direction (e.g., angular deflection). The timing difference between these two pulse trains is indicative of the angular deflection of the ball flight. Within the swing arm connector 1220, and after some amount of analog filtering to remove noise and improve signal quality, the three signals are fed to a first microcontroller. This first microcontroller is the main controller in the swing arm connector 1220. Algorithms within the firmware of this microcontroller are able to use these three analog signals to compute the speed and direction of the ball flight.

Speed and direction information is then fed to a second microcontroller within the swing arm connector 1220. This second microcontroller is a controller for use with USB interfaces. The second microcontroller accepts the speed and direction information from the first microcontroller and formats the speed and direction information according to the HID and USB standards (or other standards being used). Once the speed and direction information is properly formatted, the information is transmitted through the standard USB interface to the personal computer.

The driver software 1230 monitors the USB ports of the personal computer. Upon arrival of properly formatted speed and direction information from the swing arm connector 1220, the driver software 1230 converts this information into simulated game controller movement, here mouse movement, such as by the method described herein. The driver software 1230 provides the converted data to the operating system buffer that is used for such game controller input, where such data may be retrieved by the video game software as it retrieves mouse or other controller data and used to drive the game realistically, including control of the movement of game characters. Accordingly, the driver software 1230 operates independently and invisibly to the video game. It should be noted, however, that in alternate embodiments the data may be provided to the video game in other ways, including retrieved by the video game.

More specifically, the driver software 1230 utilizes the speed and direction information to synthesize mouse translation information. Algorithms within the driver software 1230 synthesize mouse movement data based upon the type of mouse motion or clicking that would be necessary to drive the video game software to effect a swing that would simulate the actual swing speed and direction as measured by the swing arm assembly 1210. Such algorithms are described above in connection with the aforementioned embodiments.

In certain embodiments, the driver software 1230 is also able to determine certain settings and information from the video game software through the use of graphic capture and pattern recognition. Such settings and information, may include, but are not limited to swing type (such as full, chip, putt), golf course name being played on the video game software, or the location of the ball in the video game after a user's swing. The video game software may at various times display, on a visual display device, such as monitor, television, PDA, or the like, certain game settings or game information relating to the game, such as golf course information, club information and swing information, or other output from the video game software (herein “game settings”). For example, it may be useful for the driver software 1230 to recognize, extract, and/or utilize such game settings to facilitate compatibility between the video game software and the system or method of the present embodiment. Traditionally, access to the source code of the video game software or some form of interprocess communication was needed to obtain such game settings from the video game software. As will be appreciated by those skilled in the art, the pattern recognition of the present embodiment obviates the need for such interprocess communication.

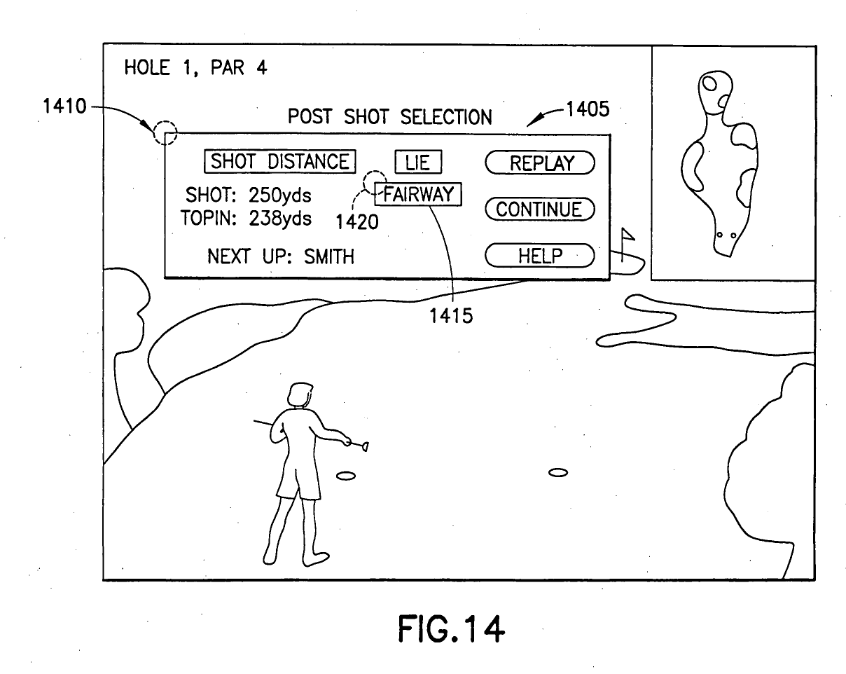

An optional feature, in this embodiment of the present invention, the driver software 1230 recognizes and extracts game settings from the video game software by capturing screen images of game settings (either full screen images or partial screen images may be used) displayed on the user station 90, and using image processing and pattern recognition technology to analyze these captured images. In certain embodiments, the driver software 1230 checks for images at specific points during the playing of the video game software, such as before or after the player swings. The images that are analyzed by the driver software 1230 and the point at which the driver software 1230 checks for images may vary depending upon the video game software that is being used in connection with the system. The following example, in connection with FIG. 14, describes the manner in which image processing and pattern recognition technology is used by the present embodiment.

First, template images are collected during the development of the driver software 1230 and saved in data files. In the preferred embodiment, the template images are collected by viewing the video game software to be used in connection with the system and recording template image information about one or more screen images representing game settings that appear during the course of playing the video game software in a data file stored in the driver software 1230. Such template image information may include the image or a representation of the screen image, the area or portion of the screen on which the image may be found, such as in terms of pixels or other two-dimensional coordinate values, the point or time at which the image appears during the playing of the video game, how the image effects or alters the playing of the game, and the like. For example, FIG. 14 illustrates a screen of Microsoft Links 2003 golf video game, which may be used in connection with certain embodiments of the present invention. Template image information may be collected regarding the post shot selection by the user, such as the screen image displayed for the post shot selection 1405, the ball lie screen image 1415 displayed within the post shot selection screen image representing the particular type of ball lie after a swing (e.g., fairway, green, fringe, sand), the location in pixels of both the larger and smaller screen images on the screen, and the point during the game at which the screen images appear, such as following a swing by the user. In general, the relative distance and direction between the reference point 1410 and the ball lie screen image 1415 is known, so that the reference point 1410 can be identified and then, the ball lie screen image 1415 can be identified and “read”. The ball lie screen image 1415, shown as “Fairway” can then be matched to one of the potential lies, such as “Fairway”, “Green”, “Fringe”, or “Sand”. The particular images and information presented to users in these images are a matter of design choice. Notably, the present embodiment may be used regardless of the images or information chosen.

Second, during game play, the driver software monitors the video game screen for the appearance of images that represents a game setting in certain locations at certain times during the playing of the game, based on the template image information gathered and stored in data files in the driver software 1230. For example, based on the template image information, the driver software 1230 may know to monitor the screen for a screen image representing the post shot selection within which a small screen image representing the lie of the golf ball may be located after each swing of the golf club by the user. The relative location between a certain reference point 1410 on the post shot selection screen image 1405 and a reference point 1420 on the smaller ball lie screen image 1415 within the post shot selection screen image 1405 might by fixed for a certain screen resolution.

Third, when a screen image is detected, the driver software 1230 identifies the reference points of the screen image. For example, where the driver software 1230 detects that a screen image has appeared after a golf club swing by the user, the driver software 1230 identifies the reference points or pixels at which the screen image is located on the screen.

Fourth, the pixels or other coordinates used to identify the location of the desired screen image being analyzed is adjusted by the driver software 1230 to be compatible with the resolution settings of the video game software. Where a desired smaller screen image is located within a larger screen image, the fixed distance between a reference point on the larger screen image (e.g., post shot selection image 1405) and a reference point on the smaller screen image (e.g., ball lie image 1415) within the larger screen image may be similarly adjusted to the resolution of the video game software. The driver software 1230 may determine the resolution settings through the interface of the operating system used in connection with the user station 90, for example, the WINDOWS API.

Fifth, the driver software 1230 compares the adjusted location of the desired screen image being analyzed with the stored template image information that is representative of the game setting being analyzed and the maximum image correlation is found. The image correlation is the degree to which the screen image extracted during play of the game matches a template image. If two images are exactly the same, correlation is said to be 100%. If two images are totally different the correlation is said to be 0%. In this embodiment, the correlation between extracted images and template images will be less than 100% and greater than 0%. The greater the value of the correlation between two images, the more similar the two images are. The driver software 1230 will compute the correlation between an extracted image and one or more of the stored template images. The template image which has the highest degree of correlation with the screen image will be considered to have the maximum correlation. In this embodiment, the degree of correlation may be determined using a pixel-by-pixel or point-by-point comparison of the screen image and the template image. If the difference between the extracted image and any template image is below a certain threshold, for example, only a certain number of pixels are different, the driver software 1230 considers that these two images are the same. In alternate embodiments, other methods of correlation known in the art may be used.

For example, the location of the post shot selection screen image 1405 in FIG. 14 is adjusted to the resolution settings for the operating system of the user station 90 on which the video game is being run. The driver software 1230 may now search the stored template image information for a potential matching image based on the adjusted location of the post shot selection screen image 1405 and the point during the game at which the post shot selection screen image 1405 appeared on the screen. Once the driver software 1230 has determined, the stored template image that matches the post shot selection screen image 1405, the driver software 1230 may then determine the lie of the golf ball based on the adjusted location distance of the smaller ball lie screen image 1415 within the post shot selection screen image 1405 and a pixel-by-pixel comparison to determine with which stored template image does the maximum correlation exist.

Sixth, the driver software 1230 recognizes the template image with the maximum correlation to the screen image and determines that a certain game setting exists based on the template image information stored in the data file corresponding to the template image. In this example, the maximum correlation for the ball lie image 1405 would exist with the template image of the “Fairway”, and thus, based on the template image information for fairway, the driver software 1230 may apply the proper conversion algorithm (e.g., that of full swing mode) to the next golf club swing data received from the swing arm connector 1220, as described herein, to properly simulate the next golf club swing by the user to be from the fairway.

The storage of data will now be described in greater detail for this embodiment.

The swing arm assembly 1210 transmits signals when the ball is in motion. The swing arm connector 1220 stores in a first microcontroller 1302 firmware algorithms utilized to calculate ball flight speed and direction. The swing arm connector 1220 also stores firmware in a second microcontroller to format speed and direction data according to the HID specification and transmit this information through standard USB protocols to the USB port on the user station 90. The driver software 1230 may store date/time, speed, direction and swing type for each swing taken.

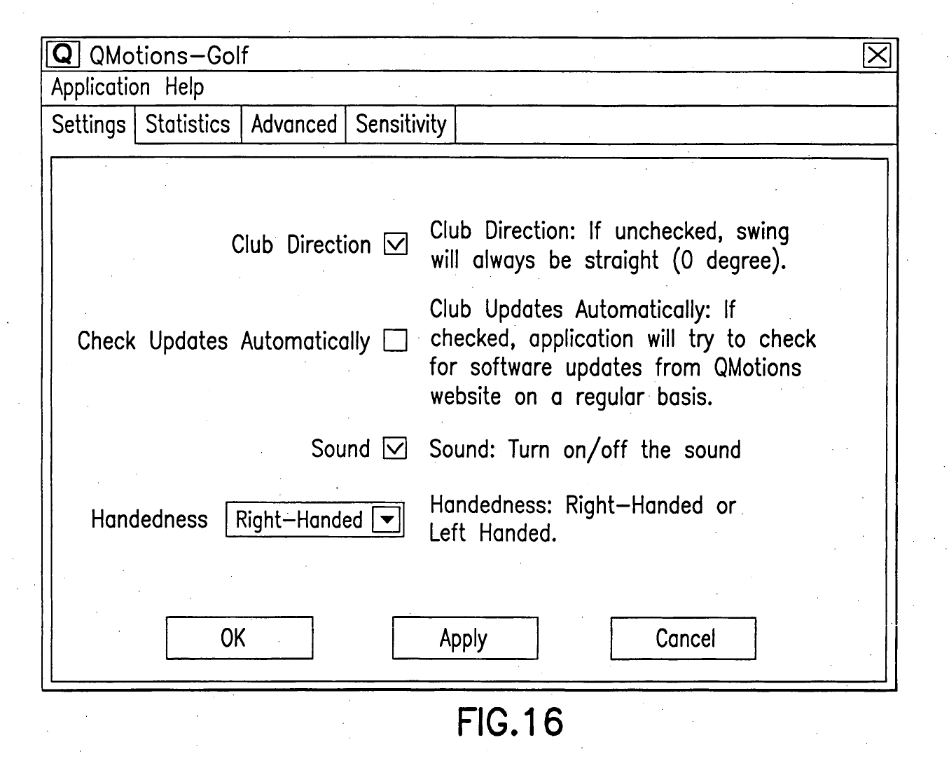

The driver software 1230 may also store data relating to the handedness of the player, club direction preference, preference for checking on-line updates automatically, swing mode detection capability, and which keys are to be used when manually selecting swing mode. The driver software 1230 may also store swing data such as date/time, swing speed, swing direction, swing mode and alternatively, club type. For example, in certain embodiments, the driver software 1230 may be used without any video game software. When the driver software 1230 is used without video game software, the club type will be recorded by the driver software 1230 in addition to the speed and direction resulting from a swing. According to one embodiment of the present invention, as illustrated by FIG. 16, the user may choose settings such as whether the user is right-handed or left-handed and whether club direction should be taken into account via a graphical user interface displayed on the user station 90.

In certain embodiments, this swing data can be uploaded to a service for swing analysis, via any type of wired or wireless transmission, such as the Internet, intranet, world wide web, local area network or other connection, using essentially any type of communication protocol. In such embodiments, the driver software 1230 may have the ability to upload swing speed and direction date/times golf course, hole user's score, or any other information collected from the sensor or video game to the service for each swing made while the driver software 1230 is running on the user station or while it is not running (e.g., transmitted by a swing arm connector) communicating with the service.

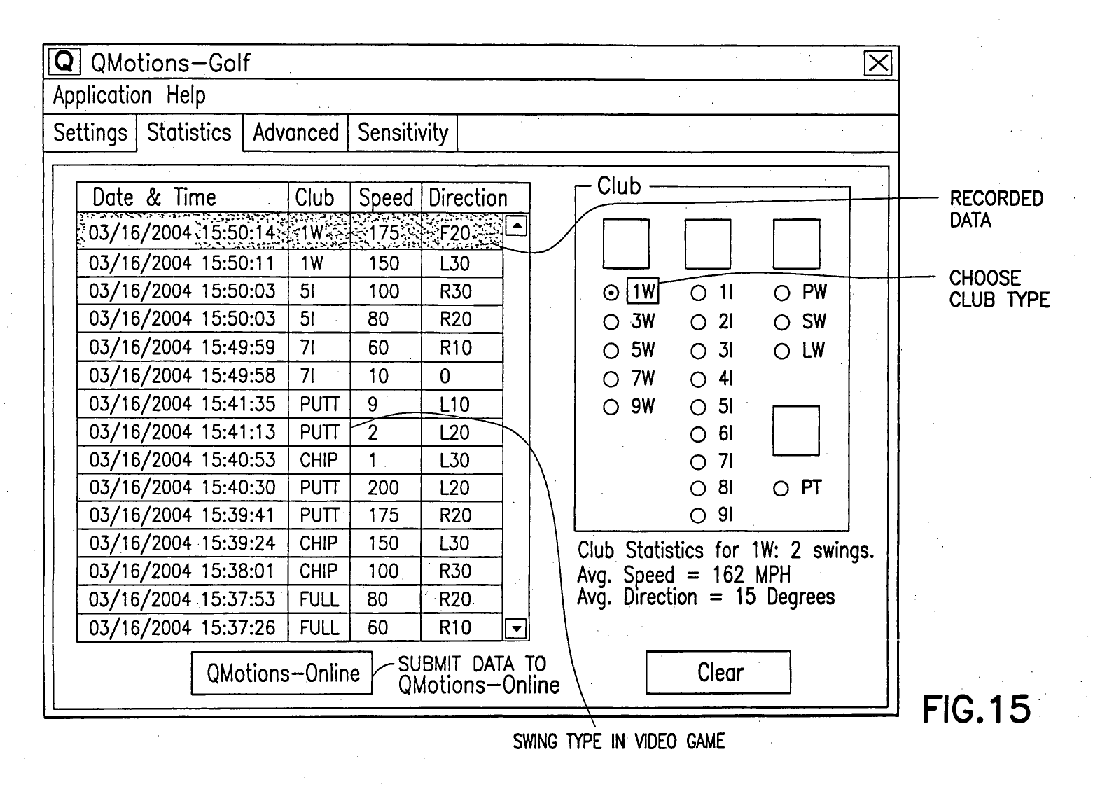

In one embodiment, the driver software 1230 can be run in what is referred to as “Statistics” mode which does not require any interaction with the video game software. As illustrated by FIG. 15, in Statistics mode the user may select which club he/she is actually using for each swing via a graphical user interface displayed on the user station 90. The data uploaded to the service, includes not only speed and direction, but also the actual club type being used by the user. In this embodiment, also illustrated in FIG. 15, the date, time, swing type, club type, speed, and/or direction of each swing may also be recorded and uploaded to provide an analysis of the user's performance over a period of time, such as average distance or direction with a certain club type. The data may be uploaded electronically via a network, such as the internet or a local area network, and the analysis (e.g., average distance, speed, direction for any or all clubs, etc.) of the user's performance may be automated and provided via a software program running on a server, such as a web server, or manually by a person analyzing the data and preparing a written or electronic report. This statistics data may also be stored on the driver software 1230 and viewed by the user or may be uploaded for analysis via the graphical user interface displayed in FIG. 15.

In other embodiments, the service is used in conjunction with the video game software. Where the service is used with certain video game software, such as Microsoft Links 2003, it may be possible during the play of the game to extract additional information as computed by the video game software, such as total distance ball traveled, distance from the pin, club used in the game, par of the hole, course being played, and the like, using the method of graphic capture and pattern recognition described above. The service may process the data in a variety of manners to provide analysis to the user, such as electronically or manually, through the use of pie charts, bar graphs, time series, or even plots of ball locations on facsimiles of a given hole on a give golf course, and the like.

The conversion of user swing measurements into mouse controller input data performed by the driver software 1230 will now be described for this embodiment.

In the sensitivity Tab, there are three sliders which can adjust the parameters we use in the algorithm to decide how to adjust or transform the speed to control the video game. Basically, the more sensitivity selected, the less real speed is required to cause the golf ball to travel a certain distance. Default values can be restored by using the Default button. The Sensitivity parameters have effect on the algorithms described herein, since it converts real speed to the speed value used in such algorithms. For example, a user swings his club at 30 miles/hour (which is measure by the sensor, for example, indirectly by the speed of the ball rotating about the axis). If the sensitivity value is 0.5, then the speed value used in algorithm is 30 miles/hour divided by 0.5, which equals 60 miles/hour. So, in the video game, the golf ball flies further than it does in the real world. Such sensitivity adjustment is optional and can be adjusted wither manually by a user or automatically, by the driver software (for example, based on club, video game player selected, the players skill level (e.g., advanced, intermediate or beginner), and/or other factors).

When converting the swing measurements into mouse controller data, the mouse controller movement distance computed by the driver software 1230 may be implemented in multiple incremental movements instead of a single large game controller movement to ensure proper simulation of the user's swing. For example, where the speed and direction data representative of the user's swing is converted into a mouse controller movement distance of more than fifty pixels, for example, such a large mouse controller movement distance would not be accurately understood by a video game, such as LINKS 2003. Where the mouse controller movement distance computed by the driver software 1230 would be too large to be accurately understood by the video game, the mouse controller movement distance is represented by several, smaller incremental mouse controller movement steps. For each different swing mode, such as putting, chipping and full swing, the length of the mouse controller movement step is different. Swing modes may include putting, chipping, and full swing. It is possible to define additional swing modes to achieve more accurate and realistic results.

An exemplary process for converting exceptionally large swing data into game controller movement data (mouse controller movement data in this example) that can be understood by a video game according to one embodiment of the present invention will now be described below with reference to the pseudocode below. Where mouse controller movement data is too large for a particular video game to handle all at once, the speed and angle (direction) data received from the swing arm connector 1220 may be converted to mouse movement through the use of lookup tables that are programmed into the driver software 1230. Therefore, depending on the desired result and video game, it may be necessary to break up the large mouse controller movement data from one large movement to multiple smaller movements. For example, a mouse movement of 100 pixels may need to be broken into increments of 25 pixels for a putt (MAX_LOOP_STEP_PUTT) or a chip (MAX_LOOP_STEP_CHIP), and increments of 50 pixels (MAX_LOOP_STEP_NORMAL) for a full swing.

The code determines how many times (distance_number) the step (R) goes into the distance. This determines how many incremental moves are required to represent the total distance. The codes loops through creating controller data, with any fraction of a step being accounted for also.

Input: distance; Output: distance_loop( ) and distance_number
If club is in a) Puffing status; or b) Chipping status; or c)
Full swing status, then Let R
= MAX_LOOP_STEP_PUTT, MAX_LOOP_STEP_CHIP,
MAX_LOOP_STEP_NORMAL, respectively.

distance_number = distance / R
For k = 0 To distance_number-1

distance_loop(k) = R

Next k
If (distance_number >= 1) Then

distance_number = distance_number-1

Else

distance_loop(distance_number) = distance

End If

The interaction between the driver software 1230, the user station 90 (i.e., personal computer in this embodiment), and the video game software will now be described in greater detail for this embodiment.

The primary means of interaction between the driver software 1230 and the video game software is through the serial port buffer of the personal computer's operating system. It is by this means that the speed and direction data as measured by the swing arm assembly 1210 and the swing arm connector 1220 are converted to input device data, such as by the method described herein, and utilized to drive the video game software to simulate the actual swing taken by the game player.

Other interactions between the driver software 1230 and the video game software involves the ability of the driver software 1230 to determine certain settings established in the video game software. Depending on the video game software being used, available settings, such as swing type, club type, flight distance, total distance, distance to the pin, which course is being played, par rating of the course being played, hole being played, which shot on the hole is being taken, where ball lies, (green, rough, sand pit, etc.), can be determined by the driver software 1230. This may be accomplished by capturing screen graphics and then utilizing pattern recognition algorithms to determine the various game settings, as described above.

Similarly, the driver software 1230 may automatically determine the current swing mode of the video game software, for example, if the game player is in a full swing situation, chip situation or putting situation, by using pattern recognition, although such manual input is within the scope of the present invention. This circumvents the need for the player to manually inform the driver software 1230 of the swing mode through the use of key presses on the keyboard or other manual input, although such manual input is within the scope of the present invention. The driver software 1230 may be able to more accurately simulate the user's swing by recognizing the swing mode environment of the video game software. As noted above, in certain embodiments, the driver software 1230 may recognize three swing modes in order to properly scale the synthesized mouse movement: full, chip or putt. It should be understood, however, that is within the scope of the present invention not to use pattern recognition, to determine swing modes, or to scale (or step) controller data.

The user interface utilized by this embodiment will now be described in greater detail.

The driver software 1230 in this exemplary embodiment has the following settings, which can be set through keystrokes in the present embodiment.
a. Club Direction—whether the software should include directional information in the simulated mouse movements fed to the video game software.
b. Check Updates Automatically—enables periodic check of on-line service to see if there are any bug fixes or other updates for the application software.
c. Handedness—select based upon whether the player is playing right-handed or left-handed.
d. Swing Mode (set to manual or automatic)—when set to manual the user must press a keyboard key which is indicative of the swing mode that the game is in, e.g., full swing, chipping, or putting; When set to automatic the driver software 1230 is able to determine the current swing mode environment for the video game software.
e. Mode Change Keys—this option allows the user to select the keys that will be used in manual swing mode to set the different swing modes.

The driver software 1230 may also capture swing mode, swing speed and direction from swings that are made while playing the video game software. There is also a statistics mode by which the player can manually select which club he/she is using and have the club type be recorded along with swing speed and direction. Capturing club type is in lieu of capturing the swing mode, for example, with a putter corresponding to putting mode, a chipper or wedge corresponding to chipping mode and all other clubs corresponding to full swing.

A player may operate the present embodiment of the invention by first launching the driver software 1230 on the user station 90, and then launching the gaming software on the user station 90. Where the player wishes to use the statistics mode while playing, he or she may choose the club type through a graphical user interface or other interface before each swing. At this point the player is ready to swing the club. Between each golf club swing a green LED (light emitting diode) located on top of the swing arm connector 1220 will blink to indicate that the swing arm connector is processing data. The player should wait for the green LED on the top of the swing arm connector 1220 to remain steadily lit before swinging the golf club again. Such signals may be provided by either the driver software 1230 or swing connector 1210. Additionally, between each golf club swing, the driver software 1230 may receive additional game setting information through graphic capture and pattern recognition, such as club type or swing type. The driver software 1230 may also extracts information, such as club type, as selected in the statistics tab of the driver software 1230. When the player swings the golf club, the swing arm assembly 1210 measures speed and direction of the simulated golf ball 1302. The swing arm connector 1220 processes the swing data of the swing arm assembly 1210 and sends the swing data via HID, USB, or any suitable communications standard to the host user station 90. The driver software 1230 monitors the USB ports of the user station 90 and receives the speed and direction from the swing arm connector 1220. The driver software 1230 converts the swing data to mouse controller movement data and sends this data to the operating system. The video game software will enable the player to see a game character player swinging simulating their own swing, based on the data gathered from the swing arm assembly 1210.

It is to be understood that the present invention may utilize a sensor unit, like the swing arm assembly in other applications. For example, a swing arm assembly in which the ball is suspended on a horizontal arm that is rotatable around a vertical post may be used to sense a baseball being hit for use as an input to a baseball video game instead of mouse or other controller input. The speed of rotation about the vertical post provides the speed of the ball (and thus equates to distance) and the deflection from the plane of the ball in the static position provides the trajectory of the ball. In other baseball game embodiments, the swing arm assembly mirrors that in the aforementioned golf embodiment, namely the ball suspended on a vertical (while at rest) shaft, which is rotatable around a horizontal axel.

Those skilled in the art will recognize that the method and system of the present invention has many applications, may be implemented in many manners and, as such, is not to be limited by the foregoing exemplary embodiments and examples. Additionally, the functionality of the components of the foregoing embodiments may be implemented in different manners. Further, it is to be understood that the steps in the foregoing embodiments may be performed in any suitable order, combined into fewer steps or divided into more steps. Thus, the scope of the present invention covers conventionally known and future developed variations and modifications to the system components described herein, as would be understood by those skilled in the art.

1. A system for use with a computer application configured to respond to first input device data from a first input device, the first input device having a first format, the system comprising:
a second input device, different than the first input device, the second input device including one or more sensors configured to measure movement of an object and creating second input device data representative of the movement of the object, the second input device data having a second format different than the first format; and
a processor configured to convert the second input device data into simulated first input device data, the simulated first input device data having the first format, the processor further configured to provide the simulated first input device data to the computer application, thereby simulating the first input device with the second input device.

2. The system of claim 1, further comprising a transmitter configured to communicate the second input device data to the processor.

3. The system of claim 2, wherein the transmitter is a transceiver configured to allow two-way communication of data between the second input device and the processor.

4. The system of claim 3, further comprising sensor firmware configured to recognize that data is being sent from the processor to the second input device.

5. The system of claim 1, wherein the computer application is a video game.

6. The system of claim 1, wherein the first input device is one of the following devices:
a mouse, a joystick, or a keyboard, and the first input device data is mouse controller input data, joystick controller input data, or keyboard input data.

7. The system of claim 1, wherein the object is a golf club and the second input device is attached to the golf club.

8. The system of claim 1, wherein the object is a system user's arm and the second input device is attached to the system user's arm.

9. The system of claim 1, wherein the one or more sensors are accelerometers configured to measure the acceleration and angle of the object in one or more directions and the second input device data is representative of the acceleration and angle of the object.

10. The system of claim 9, further comprising sensor firmware, wherein the acceleration of the object is measured directly from the one or more accelerometers and the angle of the object is computed by the sensor firmware.

11. The system of claim 10, further comprising a transmitter configured to communicate the second input device data to the processor, wherein the second input device additionally sends calibration data for the accelerometers to the processor to facilitate calculation of the angle of the object.

12. The system of claim 11, wherein the transmitter is a transceiver configured to allow two-way communication of data between the second input device and the processor, and wherein data is sent from the processor to the second input device requesting the calibration data.

13. The systemof claim 1, further comprising a sensor processor configured to assemble the second input device data into data frames to communicate to the processor configured to convert the second input device data.

14. The system of claim 13, wherein each data frame includes acceleration and angle measurements for the object.

15. The system of claim 1, wherein the processor further comprises driver software, configured to convert the second input device data into simulated first input device data.

16. The system of claim 1, wherein the one or more sensors indicate multiple potential positions of the object at a given time and the processor determines in which of multiple potential positions the object is located.

17. The system of claim 16, wherein the object is a golf club and the multiple potential positions include potential locations of the golf club in multiple quadrants of 90 degrees.

18. The system of claim 1, wherein the processor is configured to receive a certain amount of first input device data at a given time and the processor divides the simulated first input device data into multiple smaller portions of the certain amount of the simulated first input device data to provide to the computer application.

19. The system of claim 1, wherein the processor is configured to have a first mode and a second mode, wherein in the first mode a first movement results in a first simulated input resulting in a first movement of a game character, and wherein in the second mode the first movement results in a second simulated input resulting in a second movement of the game character.

20. A system for converting movement of an object from a first format into input device data of a second format that a computer application is configured to receive, the system comprising
a sensor unit including:
one or more sensors configured to measure movement of the object in one or more directions and create a signal representative of the movement of the object in a first format; and
a transmitter configured to communicate the signal; and
a user station having driver software configured to receive the signal, convert the signal into simulated input device data having the second format, and provide the simulated input device data to the computer application.

21. The system of claim 20, wherein the transmitter is a transceiver configured to allow two-way communication of data between the sensor unit and the user station.

22. The system of claim 21, wherein the sensor unit further includes sensor firmware configured to recognize that data is being sent from the user station to the sensor unit.

23. The system of claim 20, wherein the computer application is a video game.

24. The system of claim 20, wherein the input device is a mouse, and the input device data is mouse controller input data.

25. The system of claim 20, wherein the object is a golf club and the sensor unit attaches to the golf club.

26. The system of claim 20, wherein the object is a system user's arm and the sensor unit attaches to the system user's arm.

27. The system of claim 20, wherein the one or more sensors are accelerometers configured to measure the acceleration and angle of the object in one or more directions and the signal is representative of the acceleration and angle of the object.

28. The system of claim 27, wherein the sensor unit further includes sensor firmware, wherein the acceleration of the object is measured directly from the one or more accelerometers and the angle of the object is computed by the sensor firmware.

29. The system of claim 27, wherein the sensor unit additionally sends calibration data for the accelerometers to the driver software to facilitate calculation of the angle of the object.

30. The system of claim 29, wherein the transmitter is a transceiver configured to allow two-way communication of data between the sensor unit and the user station, and wherein data is sent from the driver software to the sensor unit requesting the calibration data.

31. The system of claim 20, wherein the sensor unit further includes a sensor processor configured to assemble second input device data into data frames to communicate to the processor.

32. The system of claim 31, wherein each data frame includes acceleration and angle measurements for the object.

33. The system of claim 20, wherein the one or more sensors indicate multiple potential positions of the object at a given time and the driver software determines in which of multiple potential positions the object is located.

34. The system of claim 33, wherein the object is a golf club and the multiple potential positions include potential locations of the golf club in multiple quadrants of 90 degrees.

35. The system of claim 20, wherein the driver software is configured to receive a certain amount of input device data at a given time and the driver software divides the simulated input device data into multiple smaller portions of the certain amount of the simulated input device data to provide to the computer application.

36. A method of providing input to a computer application configured to receive first input device data having a first format, the method comprising:
measuring movement of an object in one or more directions;
creating second input device data representative of the movement of the object, the second input device data having a second format different than the first format;
converting the second input device data into simulated first input device data, the simulated first input device data having the first format; and
providing the simulated first input device data to the computer application, thereby simulating the first input device with the second input device.

37. The method of claim 36, wherein the measuring includes measuring the acceleration and angle of the object in one or more directions and the creating includes creating second input device data representative of the acceleration and angle of the object.

38. The method of claim 37, wherein the measuring further includes computing the angle of the object using sensor firmware.

39. The method of claim 38, wherein the creating further includes assembling the measured acceleration and angle data into data frames.

40. The method of claim 39, wherein each data frame includes acceleration and angle measurements for the object.

41. The method of claim 36, wherein the computer application is a video game.

42. The method of claim 36, wherein the first input device data is mouse controller input data.

43. The method of claim 36, wherein the object is a golf club and the second input device data is representative of the movement of the golf club.

44. The method of claim 36, further comprising determining in which of multiple potential positions the object is located at a given time.

45. The method of claim 44, wherein the object is a golf club and the multiple potential positions include potential locations of the golf club in multiple quadrants of 90 degrees.

46. A system of providing input to a computer application configured to receive first input device data having a first format, the system comprising:
means for measuring movement of an object in one or more directions;
means for creating second input device data representative of the movement of the object, the second input device data having a second format different than the first format;
means for converting the second input device data into simulated first input device data, the simulated first input device data having the first format; and
means for providing the simulated first input device data to the computer application, thereby simulating the first input device with the second input device.

47. The system of claim 46, wherein the measuring means further comprises means for measuring the acceleration and angle of the object in one or more directions and the creating means further comprises means for creating second input device data representative of the acceleration and angle of the object.

48. The system of claim 47, further comprising means for computing the angle of the object.

49. The system of claim 48, further comprising means for assembling the measured acceleration and angle data into data frames.

50. The system of claim 49, wherein each data frame includes acceleration and angle measurements for the object.

51. The system of claim 46, wherein the computer application is a video game.

52. The system of claim 46, wherein the first input device data is mouse controller input data.

53. The system of claim 46, wherein the object is a golf club and the second input device data is representative of the movement of the golf club.

54. The system of claim 46, wherein the second input device data indicates multiple potential positions of the object at a given time, the system further comprising means for determining in which of the multiple potential positions the object is located at the given time.

55. The system of claim 54, wherein the object is a golf club and the multiple potential positions include potential locations of the golf club in multiple quadrants of 90 degrees, along a swing path, the determining based on the swing path.

57. A method for replicating first input device data of a first input device, the first input device data having a first format, to a computer application, to control movement of a graphical representation of an object, the method comprising:
measuring movement of the object with a second input device;
creating an electronic signal representative of the movement of the object, the electronic signal having a second format different from the first format;
translating the electronic signal into replicated first input device data having the first format; and
making the replicated first input device data available to the computer application, thereby replicating first input device data from the first input device with replicated first input device data from the second input device.

58. The method of claim 57, wherein the measuring includes measuring the acceleration and angle of the object in one or more directions and the creating includes creating an electronic signal representative of the acceleration and angle of the object.

59. The method of claim 58, wherein the measuring includes computing the angle of the object using sensor firmware.

60. The method of claim 58, wherein creating the electronic signal includes assembling the measured acceleration and angle data into data frames.

61. The method of claim 57, wherein the object is a golf club and the measuring includes measuring the movement of the golf club.

62. The method of claim 57, further comprising receiving data from the computer application.

63. The method of claim 57, wherein the first input device data is mouse controller input data, the mouse controller input data not representative of the movement of the object and wherein the replicated first input device data is replicated mouse controller data representative of the movement of the object.

64. The method of claim 57, wherein the electronic signal indicates multiple potential positions of the object at a given time, the method further comprising determining in which of the multiple potential positions the object is located at the given time.

65. The method of claim 64, wherein the object is a golf club and the multiple potential positions include potential locations of the golf club in multiple quadrants of 90 degrees, along a swing path, the determining based on the swing path.

66. A computer readable medium comprising code for configuring a processor to:
provide simulated input device data to a computer application, the computer application configured to control a graphical representation of an object in response to input device data; and
translate a signal into the simulated input device data, the signal representing physical movement of the object, the signal having a signal format incompatible with the computer application and the simulated input device data compatible with the computer application, thereby simulating the input device data.

67. The computer readable medium of claim 66, wherein the computer application is a video game, and the input device data includes mouse controller data, keyboard data, joystick data or game controller data, and the signal includes acceleration or angle data of the object.

68. The computer readable medium of claim 67, wherein the video game is a golf game and the object is a golf club.

69. A system representing movement of an object as simulated input device data, the system comprising:
a sensor including the object moveably connected thereto, the sensor having output representative of movement of the object; and
one or more processors operative with application software, the application software responsive to input device data and operative with driver software to cause conversion of the sensor output into simulated input device data and to cause the simulated input device data to be made available to the application software, the application software responsive to the simulated inut device data.

70. The system of claim 69, the sensor further including an axel, wherein the object is rotatably mounted to the axel for rotation and movement in direction relative to the axel, the sensor output representative of direction and rate of rotation of the object.

71. The system of claim 69, further comprising:
a connector configured to receive the sensor output and convert the sensor output to connector output representative of speed of the object, and wherein the one or more processors are operative with the application software to receive the connector output and convert the connector output into the simulated input device data.

72. The system of claim 71, wherein the connector is further configured to convert sensor output to connector output representative of direction of the object.

73. The system of claim 70, wherein the sensor includes one or more optical emitter/detector pairs to measure the rate of rotation and direction.

74. A system for simulating a user's golf swing in a video game, the video game responsive to input device data from an input device the system comprising:
a sensor having a swing arm assembly with and a shaft and a representation of a golf ball rotatably coupled thereto, the shaft rotatable in a direction of rotation and moveable in a direction transverse to direction of rotation, and wherein the sensor is configured to measure rate of rotation of the shaft and dispacement in the direction transverse to the direction of rotation and to create sensor output representative of the rate of rotation and displacement;
a swing arm connector configured to receive the sensor output and convert the sensor output to connector output representative of speed of the golf ball representation and the displacement of the golf ball representation.
a user station having driver software configured to receive the sensor output, convert the sensor output into simulated input device data and cause the simulated input device data to be available to the video game, the sensor substituting for input device.

75. The system of claim 74, wherein the driver software is configured to make the simulated input device data available to the video game by placing the simulated input device data into memory of the user station.
